(19) United States
(12) Patent Application Publication
(10) Pub. No.: US 2021/0334043 A1
(43) Pub. Date: Oct. 28, 2021

(54) STORAGE SYSTEM AND STORAGE SYSTEM CONTROL METHOD

(71) Applicant: Hitachi, Ltd., Tokyo (JP)

(72) Inventors: Shintaro Ito, Tokyo (JP); Yoshinori Ohira, Tokyo (JP); Masakuni Agetsuma, Tokyo (JP)

(73) Assignee: Hitachi, Ltd., Tokyo (JP)

(21) Appl. No.: 17/001,795

(22) Filed: Aug. 25, 2020

(30) Foreign Application Priority Data
Apr. 22, 2020 (JP) 2020-076204

(51) Int. Cl. G06F 3/06

(52) U.S. Cl. CPC G06F 3/0659; G06F 3/0641; G06F 3/0658; G06F 3/0683; G06F 3/0611; G06F 3/0619; G06F 3/0629

(57) ABSTRACT

A technology for making effective use of resources of a storage system is provided.

The storage system includes: a plurality of storage devices that store data; and a plurality of controllers that process data input to and output from the storage devices, at least one of the controllers is capable of executing function processing on the data input to and output from the storage devices, and the storage system includes a management section that changes the controllers that process the data on the basis of whether to execute the function processing on the data input to and output from the storage devices.

### BACKGROUND OF THE INVENTION

### 1. Field of the Invention

The present invention relates to a storage system.

### 2. Description of the Related Art

JP-2014-75027-A discloses a technology for improving resource utilization efficiency of physical servers. The disclosed technology is as follows. Active virtual machines and preliminary virtual machines are aggregated and disposed on separate physical servers. Furthermore, when a virtual machine arrangement device selects a physical server on which the preliminary virtual machines are to be disposed, a physical server is selected in such a manner that the number of preliminary virtual machines to be disposed on the physical server is equal to or smaller than a predetermined threshold, the total of amounts of resources required for the standby of the preliminary virtual machines is not greater than the upper limit threshold for the resource corresponding to the physical server, and the amount of resource for the total value of the amount of resource required for the operation of N preliminary virtual machines can be ensured. Moreover, the virtual machine arrangement device avoids, as much as possible, situations in which preliminary virtual machines used in pairs with active virtual machines on the same physical server are disposed on the same physical server.

The storage system has various additional functions other than a basic function to read and write data to and from a disk in response to a request from a host. Examples of the additional functions include snapshot, remote copying, deduplication, and compression. The additional function is applied to each storage area such as a volume as needed. To apply the additional function, resources of a storage node, such as a processor processing capability and a memory capacity are required. However, the technology disclosed in JP-2014-75027-A does not take into account the need of ample resources for the additional function applied as needed.

An object of the present invention is to provide a technology for making effective use of resources of a storage system.

### SUMMARY OF THE INVENTION

A storage system according to one aspect of the present invention includes: a plurality of storage devices that store data; and a plurality of controllers that process data input to and output from the storage devices, at least one of the controllers being capable of executing function processing on the data input to and output from the storage devices, and the storage system including a management section that changes the controllers that process the data on a basis of whether to execute the function processing on the data input to and output from the storage devices.

According to one aspect of the present disclosure, it is possible to make effective use of resources of a storage system.

### BRIEF DESCRIPTION OF THE DRAWINGS

FIG. 1 is a block diagram depicting system configurations of a storage system according to a first embodiment;

FIG. 2 is a block diagram depicting hardware configurations of a storage node;

FIG. 3 is a block diagram depicting software configurations of a resource saving node;

FIG. 4 is a block diagram depicting software configurations of a highly functional node;

FIG. 5 depicts configurations of a resource saving controller and configurations associated with the resource saving controller;

FIG. 6 depicts configurations of a highly functional controller and configurations associated with the highly functional controller;

FIG. 7 depicts an example of configurations of a storage system having redundant controllers;

FIG. 8 depicts an example of a node management table;

FIG. 9 depicts an example of a controller management table;

FIG. 10 depicts an example of a volume management table;

FIG. 11 depicts an example of a logical-to-physical translation table;

FIG. 12 is a flowchart illustrating data read processing executed by a front-end section;

FIG. 13 is a flowchart illustrating data write processing executed by the front-end section;

FIG. 14 is a flowchart illustrating processing executed by the front-end section upon receiving a request from the other node;

FIG. 15 is a flowchart illustrating data read processing executed by a resource saving controller;

FIG. 16 is a flowchart illustrating data write processing executed by the resource saving controller;

FIG. 17 is a flowchart illustrating data read processing executed by a data protection section;

FIG. 18 is a flowchart illustrating data write processing executed by the data protection section;

FIG. 19 is a flowchart illustrating processing executed by the data protection section upon receiving a request from the other node;

FIG. 20 is a flowchart illustrating data write processing executed by a highly functional controller;

FIG. 21 is a flowchart illustrating data read processing executed by the highly functional controller;

FIG. 22 is a flowchart illustrating volume creation processing executed by a configuration management section;

FIG. 23 is a flowchart illustrating storage node addition processing executed by the configuration management section;

FIG. 24 is a flowchart illustrating processing for applying function processing to a volume, executed by the configuration management section;

FIG. 25 is a flowchart illustrating processing for determining a storage controller to which a storage controller currently in charge of a volume is to be changed, executed by the configuration management section;

FIG. 26 is a flowchart illustrating processing for changing a storage controller in charge of a volume, executed by the configuration management section;

FIG. 27 is a block diagram depicting system configurations of a storage system according to a second embodiment;

FIG. 28 is a block diagram depicting software configurations of a resource saving node according to the second embodiment;

FIG. 29 is a block diagram depicting system configurations of a storage system according to a third embodiment;

FIG. 30 is a block diagram depicting hardware configurations of a storage node and a drive node according to the third embodiment;

FIG. 31 depicts an example of a node management table according to a fourth embodiment;

FIG. 32 depicts an example of a controller class management table according to the fourth embodiment;

FIG. 33 depicts an example of a controller management table according to the fourth embodiment;

FIG. 34 is a flowchart illustrating storage node addition processing executed by a configuration management section according to the fourth embodiment;

FIG. 35 is a block diagram depicting system configurations of a storage system according to a fifth embodiment;

FIG. 36 depicts an example of configurations of a storage system using a storage array device;

FIG. 37 is a block diagram depicting hardware configurations of a storage array;

FIG. 38 is a flowchart illustrating data read processing executed by a front-end section according to a sixth embodiment; and

FIG. 39 is a flowchart illustrating input/output processing executed by the front-end section according to the sixth embodiment.

### DESCRIPTION OF THE PREFERRED EMBODIMENTS

Embodiments of the present invention will be described hereinafter with reference to the drawings.

### First Embodiment

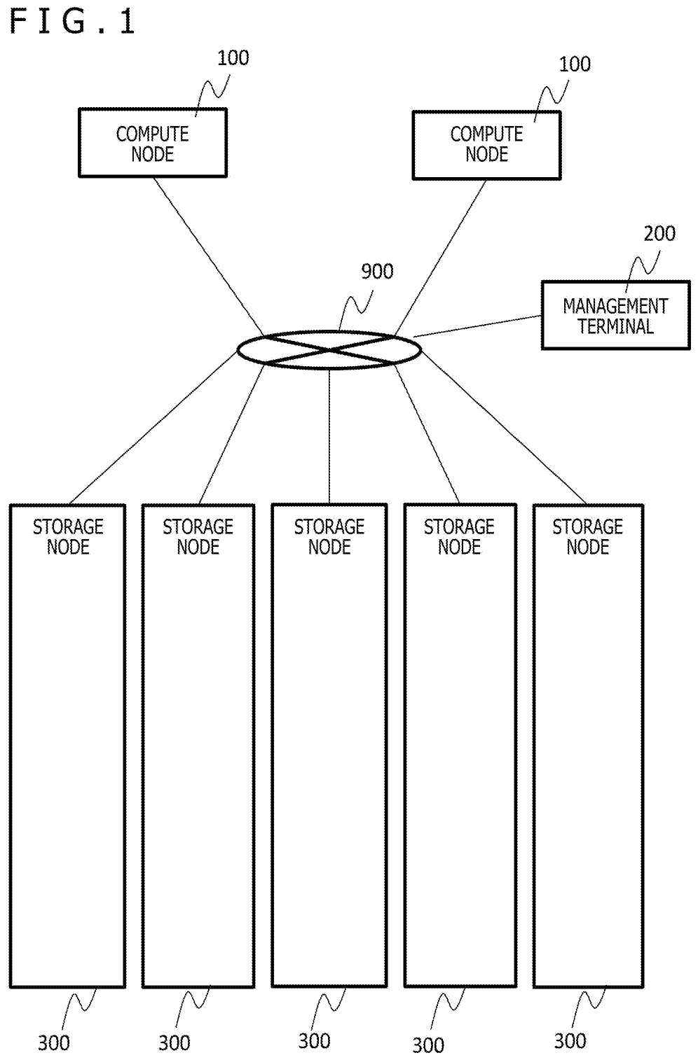

FIG. 1 is a block diagram depicting system configurations of a storage system according to a first embodiment. In the storage system according to the first embodiment, compute nodes 100, a management terminal 200, and storage nodes 300 are connected to a communication network 900. The devices mutually connected via the communication network 900 can hold communication with one another as appropriate.

Each compute node 100 is a device that serves as a host computer and that performs user's desired calculation using the storage system.

The management terminal 200 is a device for an administrator to set and operate the storage system.

Each storage node 300 is a device that provides a storage area to and from which each compute node 100 can write and read data.

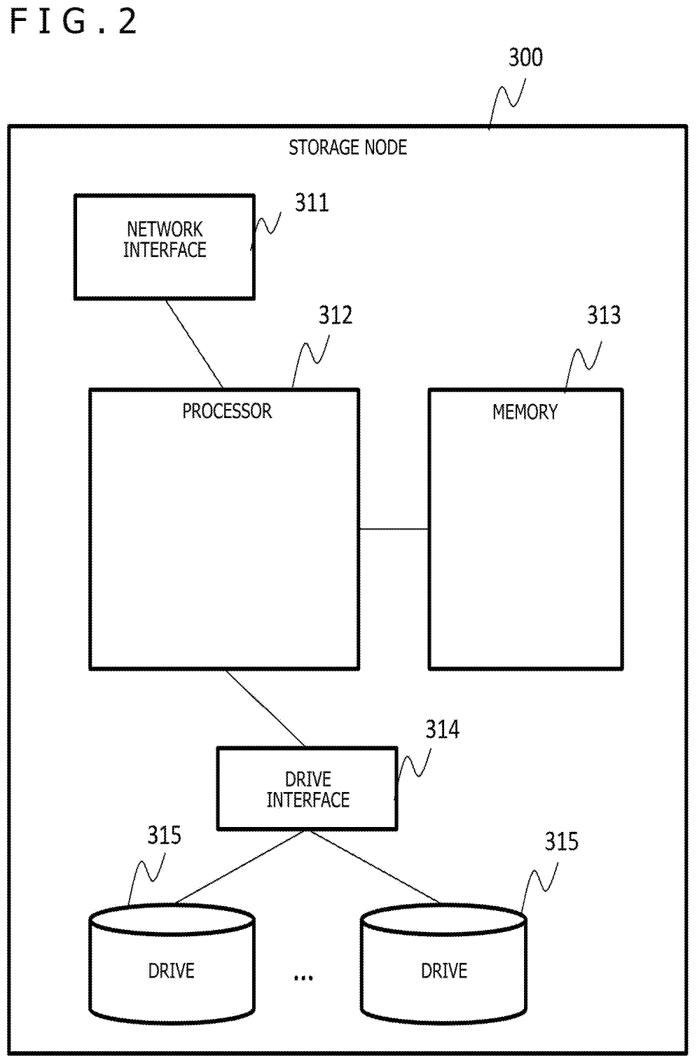

FIG. 2 is a block diagram depicting hardware configurations of the storage node. The storage node 300 has a network interface 311, a processor 312, a memory 313, a drive interface 314, and drives 315.

The network interface 311 is a device holding communication via the communication network 900.

The processor 312 executes a software program and executes desired processing as the storage node 300. The memory 313 stores the software program executed by the processor 312 and data used by the processor 312 in processing.

The drive interface 314 is an interface relaying input/output processing performed by the processor 312 on the drives 315. Each drive 315 is a storage device retaining the written data in a readable manner.

A software program is implemented such that each of a plurality of storage nodes 300 depicted in FIG. 2 acts as a resource saving node or a highly functional node, and each storage node 300 plays a role concerned. Roles, software configurations, and operations of the resource saving node and the highly functional node will be described later.

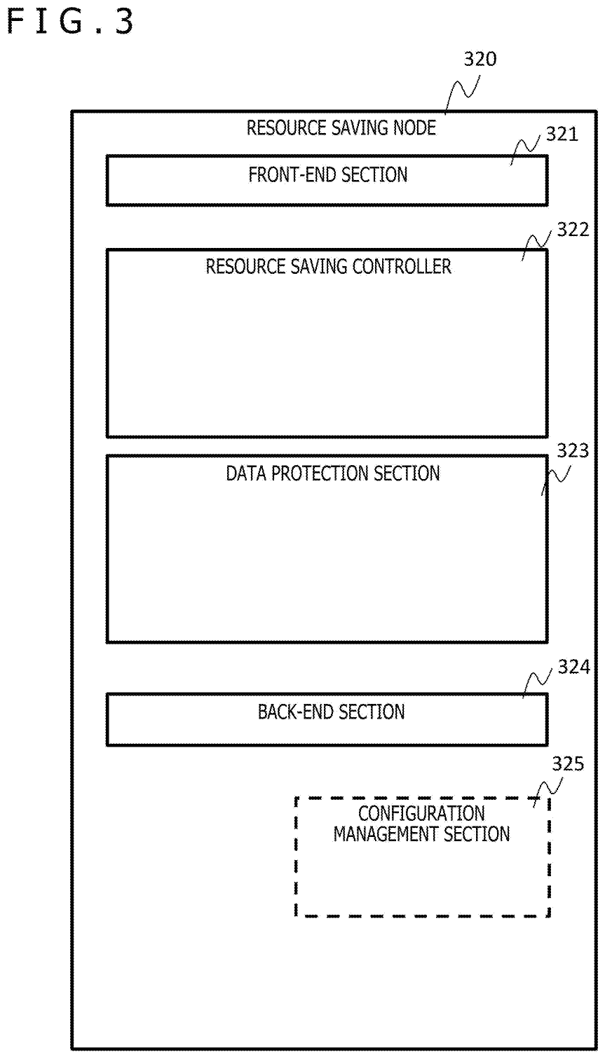

FIG. 3 is a block diagram depicting software configurations of the resource saving node. A resource saving node 320 has a front-end section 321, a resource saving controller 322, a data protection section 323, a back-end section 324, and a configuration management section 325. The front-end section 321, the resource saving controller 322, the data protection section 323, the back-end section 324, and the configuration management section 325 are software programs implemented in the storage node 300.

An outline of operations of each section will be described herein, while detailed operations will be described later.

The front-end section 321, which is an interface with each compute node 100, issues a request and a response, and transmits and receives data.

The resource saving controller 322 controls execution of basic input/output processing for writing data to each drive 315 and reading data from the drive 315 in response to a request from each compute node 100.

The data protection section 323 makes the data in each drive 315 redundant at a predetermined relative redundancy, and executes input of data to the drive 315 and output of data from the drive 315. As redundancy, the same data is stored in a plurality of drives 315, and the number of drives 315 storing the same data signifies herein the relative redundancy.

The back-end section 324, which is an interface with each drive 315, relays the data written to each drive 315 and the data read from the drive 315 to the data protection section 323.

The configuration management section 325 manages configurations of the overall storage system. The configuration management section 325 performs addition of a storage node 300 to the storage system, creation of a volume in the storage node 300, allocation of a controller in charge of a volume for the volume, and the like. A volume is a virtual storage area which is provided by each drive 315, and to which data is written and from which data is read. The volume may be either a logical volume or a physical volume. The configuration management section 325 manages various kinds of configuration management information (not depicted) about the overall storage system. The configuration management information is used by the resource saving nodes 320, highly functional nodes 330, the resource saving controllers 322, highly functional controllers 332, and the drives 315 in data write processing and data read processing.

It is noted that the configuration management section 325 is configured as the software program and a location where the configuration management section 325 is implemented is not limited to a specific location. For example, the configuration management section 325 may be disposed to extend over all the storage nodes 300. Alternatively, the configuration management section 325 may be disposed in one certain storage node 300 and manage the configurations of the overall storage system from the storage node 300. In another alternative, the configuration management section 325 may be disposed in a dedicated management computing machine (not depicted) and manage the configurations of the overall storage system from the management computing machine.

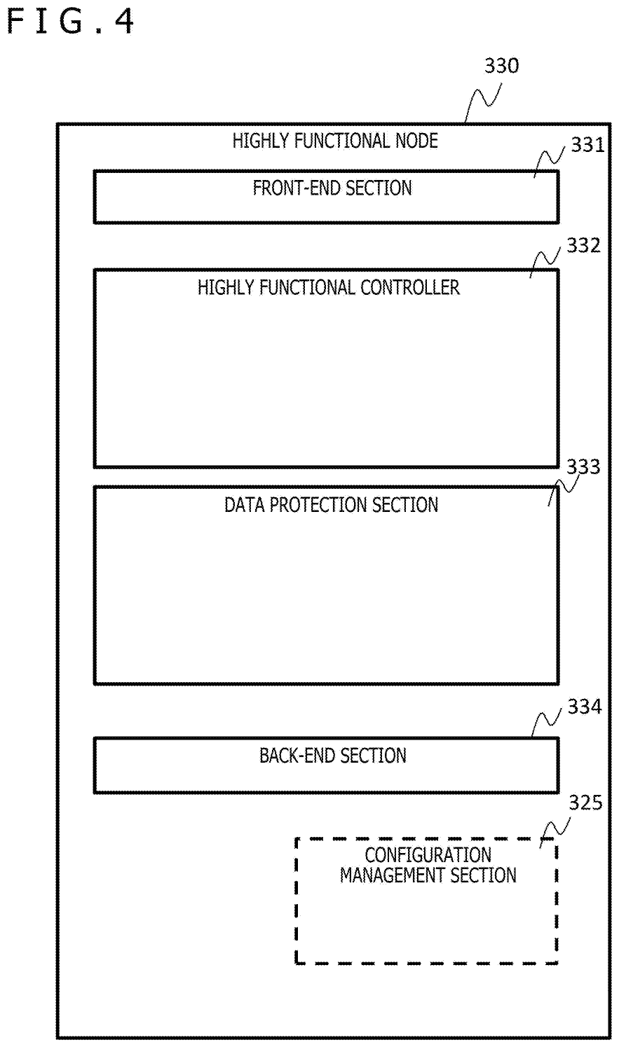

FIG. 4 is a block diagram depicting software configurations of the highly functional node. The highly functional node 330 has a front-end section 331, the highly functional controller 332, a data protection section 333, a back-end section 334, and the configuration management section 325. The front-end section 331, the highly functional controller 332, the data protection section 333, the back-end section 334, and the configuration management section 325 are software programs implemented in the storage node 300.

An outline of operations of each section will be described herein, while detailed operations will be described later.

The front-end section 331, which is an interface with each compute node 100, issues a request and a response, and transmits and receives data.

The highly functional controller 332 controls execution of basic input/output processing for writing data to each drive 315 and reading data from the drive 315 in response to a request from each compute node 100, and execution of function processing for managing data on the drive 315. In the present embodiment, types of the function processing include snapshot function processing, remote copying function processing, deduplication function processing, and compression function processing. The function processing requires a larger amount of resources than that of the input/output processing. Resources include a processor processing capability and a memory capacity.

A snapshot function is a function to acquire and record a state of a directory and/or a file at a certain point in time. In addition, in a block storage, the snapshot function is a function to acquire and record a state of a volume at a certain point in time. A remote copying function is a function to duplicate data in storage devices present in geologically different locations. A deduplication (Dedup) function is a function to save consumption of a storage capacity by eliminating duplicated copies of an identical part in a plurality of files. In addition, in the block storage, the deduplication function is a function to eliminate duplicated copies of an identical block in a plurality of volumes and to save consumption of the storage capacity. A compression (Comp) function is a function to save consumption of the storage capacity by compressing data to write the compressed data and decompressing read data. These series of function processing also include the processing for writing data to each drive 315 or the processing for reading data from the drive 315.

The data protection section 333 creates redundant drives 315, and executes writing of data to each drive 315 and reading of data from the drive 315.

The back-end section 334, which is an interface with each drive 315, relays data written to the drive 315 and data read from the drive 315 to the data protection section 333.

The configuration management section 325 in the highly functional controller 332 functions integrally with a section basically similar to the configuration management section 325 in the resource saving nodes 320 depicted in FIG. 3 or with the configuration management section 325 in the resource saving nodes 320, and manages the configurations of the overall storage system.

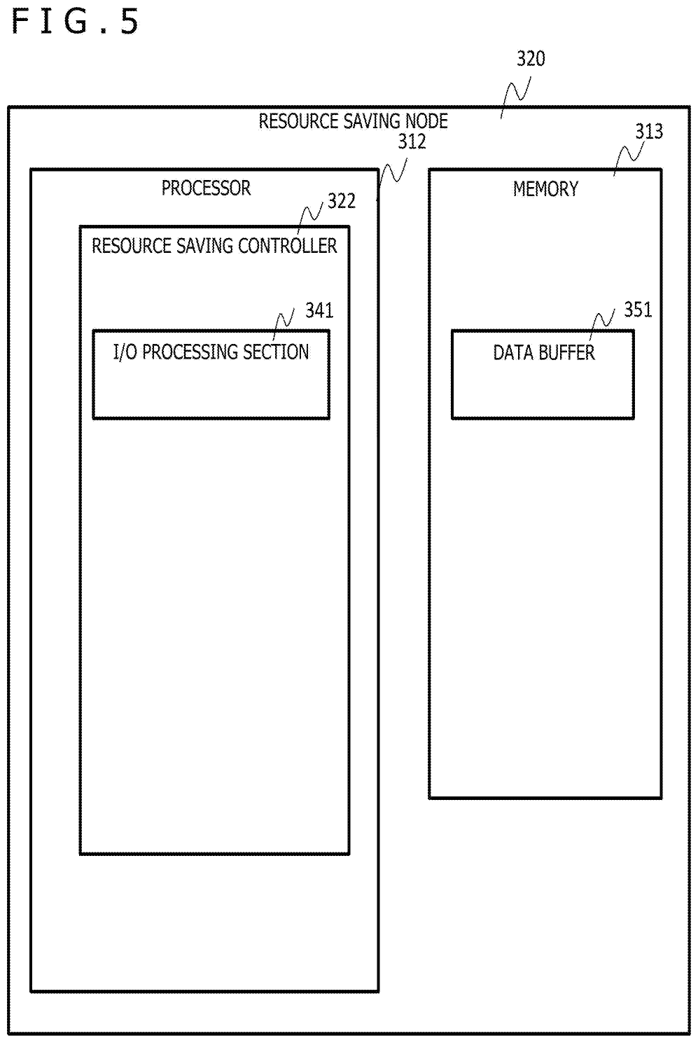

FIG. 5 depicts configurations of the resource saving controller and configurations associated with the resource saving controller. With reference to FIG. 5, the resource saving controller 322 has an I/O processing section 341. A data buffer 351 is stored in the memory 313 to be associated with the I/O processing section 341.

The I/O processing section 341 controls input/output processing on a volume of which the resource saving controller 322 takes charge, using the data buffer 351 on the memory 313.

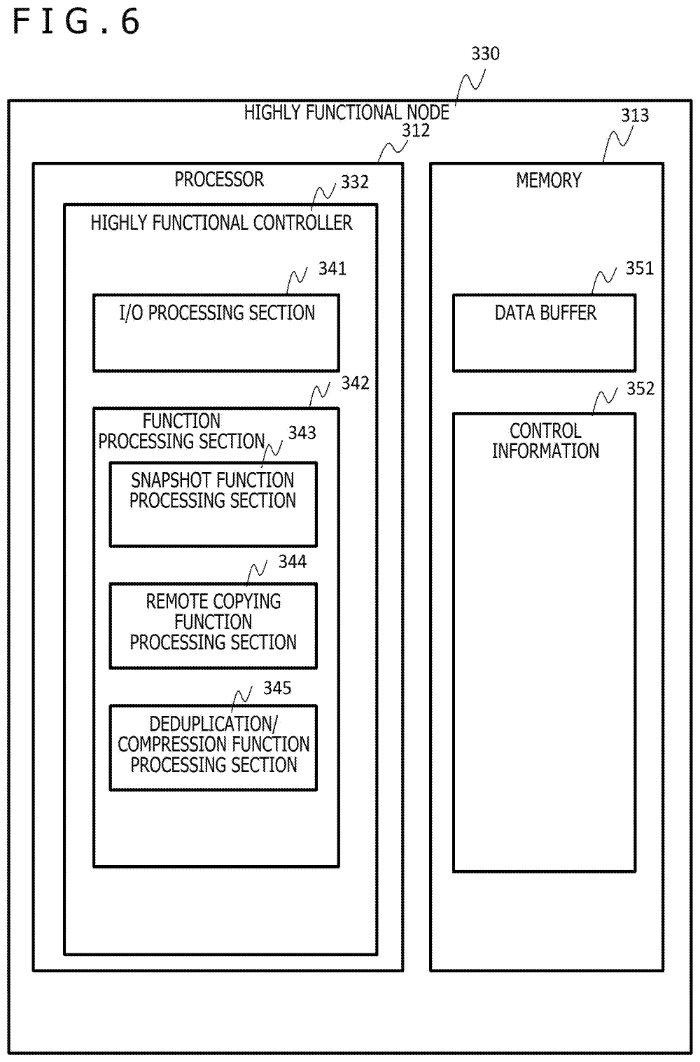

FIG. 6 depicts configurations of the highly functional controller and configurations associated with the highly functional controller. With reference to FIG. 6, the highly functional controller 332 has the I/O processing section 341 and a function processing section 342. The function processing section 342 contains a snapshot functional processing section 343, a remote copying functional processing section 344, and a deduplication/compression function processing section 345. The data buffer 351 and control information 352 are stored in the memory 313 to be associated with the I/O processing section 341 and the function processing section 342.

The function processing section 342 controls various kinds of function processing using the control information 352 on the memory 313. The snapshot functional processing section 343 controls the snapshot function processing, the remote copying functional processing section 344 controls the remote copying function processing, and the deduplication/compression function processing section 345 controls the deduplication function processing and the compression function processing.

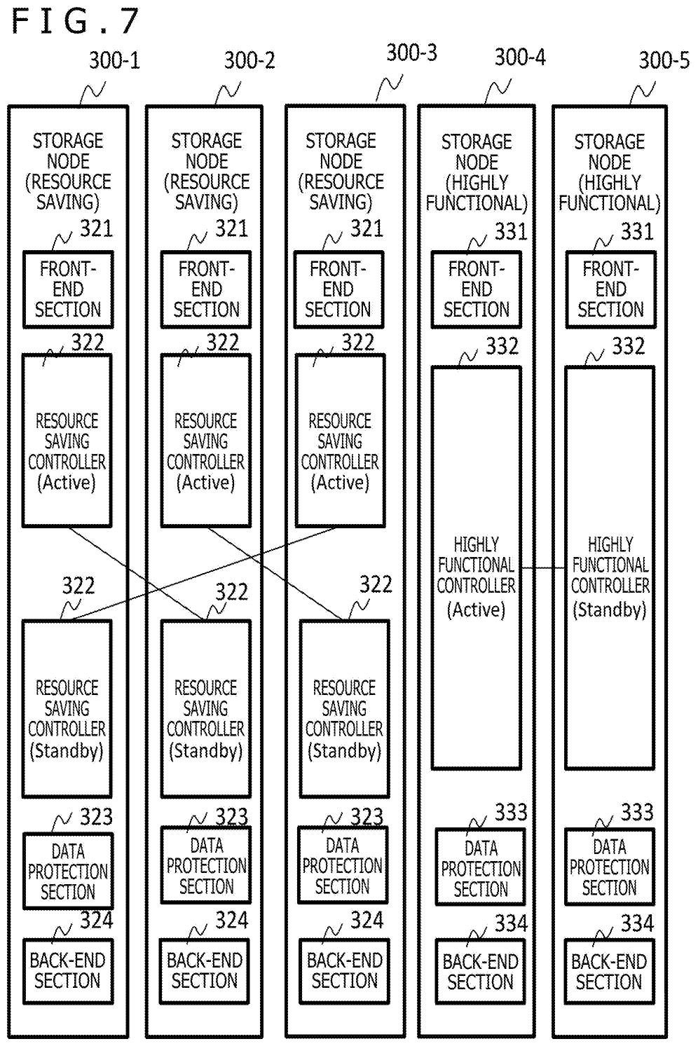

FIG. 7 depicts an example of configurations of a storage system having redundant controllers. While the resource saving controller 322 controls the input/output processing and does not control the function processing, the highly functional controller 332 controls the input/output processing and the function processing. Therefore, the resource saving controller 322 and the highly functional controller 332 differ in a necessary amount of resources. In the example of FIG. 7, redundant resource saving controllers 322 and redundant highly functional controllers 332 are efficiently disposed in the five storage nodes 300 that configure the storage system, using the difference. The redundancy is duplexing by an active controller and a standby controller.

The storage nodes 300-1 to 300-3 are defined as the resource saving nodes 320, and the storage nodes 300-4 and 300-5 are defined as the highly functional nodes 330. A standby resource saving controller 322 corresponding to an active resource saving controller 322 disposed in the storage node 300-1 is disposed in the storage node 300-2. A standby resource saving controller 322 corresponding to an active resource saving controller 322 disposed in the storage node 300-2 is disposed in the storage node 300-3. A standby resource saving controller 322 corresponding to an active resource saving controller 322 disposed in the storage node 300-3 is disposed in the storage node 300-1. A standby highly functional controller 332 corresponding to an active highly functional controller 332 disposed in the storage node 300-4 is disposed in the storage node 300-5. Duplexing the resource saving controller 322 having relatively small resources and the highly functional controller 332 having relatively ample resources makes it possible to efficiently configure the storage system striking a balance of resources and having redundant controllers.

Although not depicted in FIG. 7, each storage node 300 has the drives 315 as depicted in FIG. 2 and each drive 315 can provide a volume in the present embodiment. A storage controller and the volume over which the storage controller takes charge of control may be configured to be disposed together in the same storage node 300. For example, the active resource saving controller 322 disposed in the storage node 300-1 may take charge of a volume provided by each drive 315 owned by the storage node 300-1.

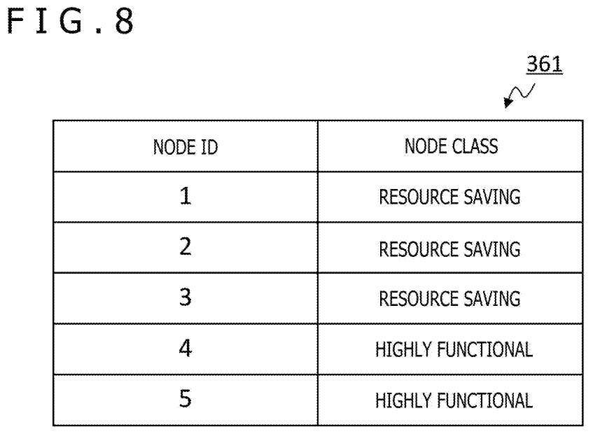

FIGS. 8 to 11 depict tables contained in the configuration management information managed by the configuration management section 325 depicted in FIGS. 3 and 4.

FIG. 8 depicts an example of a node management table. A node management table 361 is a table in which a node class of each storage node 300 included in the storage system is recorded. Node classes include the resource saving node 320 and the highly functional node 330 described above. The example of FIG. 8 corresponds to the configurations of FIG. 7. The storage node 300-1 having a node ID=1, the storage node 300-2 having a node ID=2, and the storage node 300-3 having a node ID=3 are the resource saving nodes 320. The storage node 300-4 having a node ID=4 and the storage node 300-5 having the node ID=5 are the highly functional nodes 330.

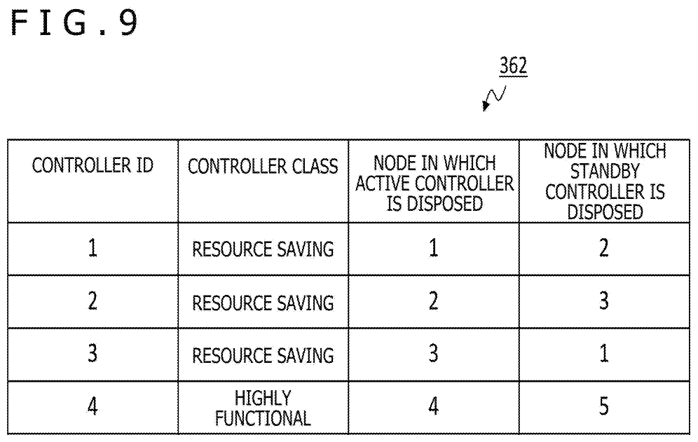

FIG. 9 depicts an example of a controller management table. A controller management table 362 is a table in which a controller class, a storage node in which an active controller is disposed, and a storage node in which a standby controller is disposed are recorded per controller. The controller classes include the resource saving controller 322 and the highly functional controller 332. The example of FIG. 9 also corresponds to the configurations of FIG. 7. The controller class of the controller having a controller ID=1 and that of the controller having a controller ID=2 are each the resource saving controller 322. The active controller having the controller ID=1 is disposed in the storage node 300-1 having the node ID=1, and the standby controller having the controller ID=1 is disposed in the storage node 300-2 having the node ID=2. The active controller having the controller ID=2 is disposed in the storage node 300-2 having the node ID=2, and the standby controller having the controller ID=2 is disposed in the storage node 300-3 having the node ID=3. The active controller having the controller ID=3 is disposed in the storage node 300-3 having the node ID=3, and the standby controller having the controller ID=3 is disposed in the storage node 300-1 having the node ID=1. The active controller having the controller ID=4 is disposed in the storage node 300-4 having the node ID=4, and the standby controller having the controller ID=4 is disposed in the storage node 300-5 having the node ID=5.

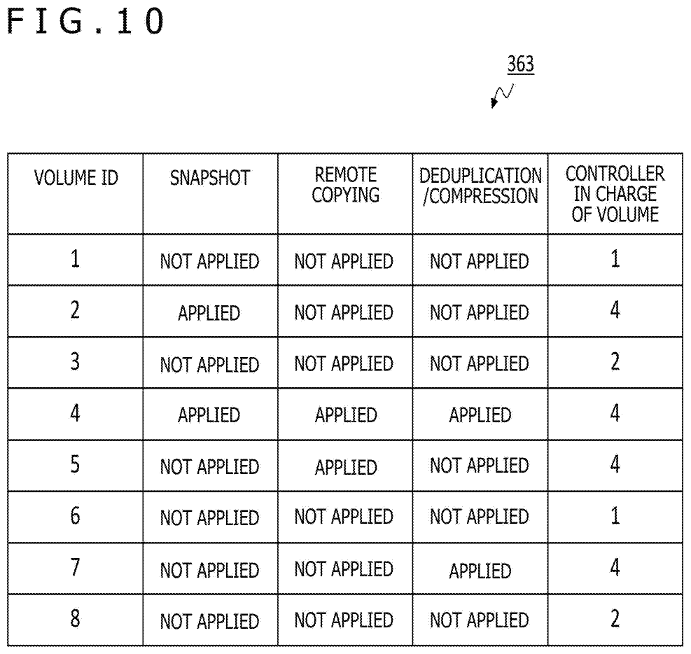

FIG. 10 depicts an example of a volume management table.

A volume management table 363 is a table in which whether to apply function processing to a volume and a controller in charge of the volume are recorded per volume. “Applied” is set to a box of each of snapshot, remote copying, and deduplication/compression in a case of applying the function processing to a volume, and “not applied” is set thereto in a case of not applying the function processing to the volume.

For example, none of the snapshot function, the remote copying function, the deduplication function, and the compression function are applied to a volume having a volume ID=1. It is the controller having the controller ID=1 that takes charge of the volume having the volume ID=1. The controller having the controller ID=1 is the resource saving controller 322 according to the controller management table 362 of FIG. 9.

Furthermore, the snapshot function is applied and none of the remote copying function, the deduplication function, and the compression function are applied to a volume having a volume ID=2. It is the controller having the controller ID=4 that takes charge of the volume having the volume ID=2. The controller having the controller ID=4 is the highly functional controller 332 according to the controller management table 362 of FIG. 9. In the present embodiment, it is assumed that the highly functional controller 332 takes charge of a volume to which even one of the series of the function processing is applied.

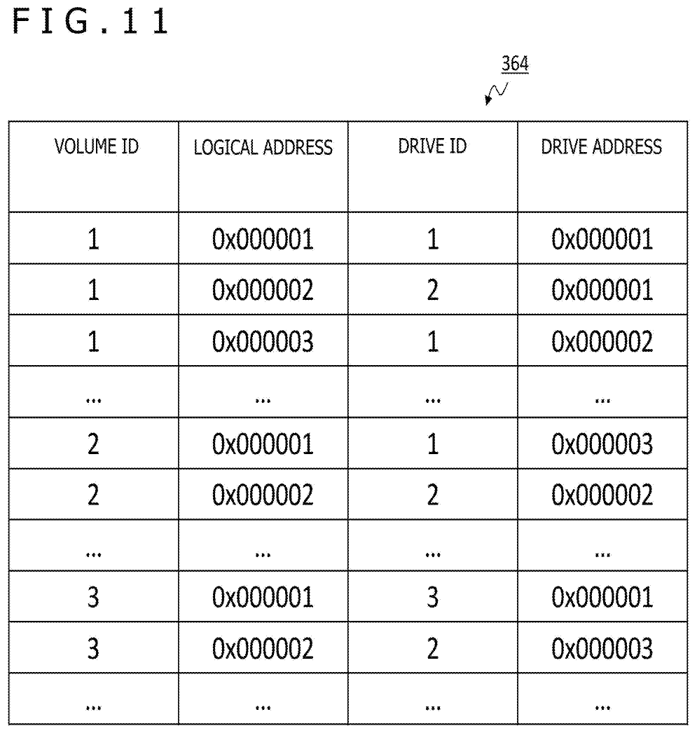

FIG. 11 depicts an example of a logical-to-physical translation table. A logical-to-physical translation table 364 is a table in which a correspondence between a logical address and a physical address is recorded. A volume ID and a logical address in a volume having the volume ID correspond to a drive ID and a physical address (drive address) in a drive indicated by the drive ID. Referring to the logical-to-physical translation table 364 makes it possible to mutually translate the logical address and the physical address.

For example, a logical address=0x000001 in the volume having the volume ID=1 corresponds to a drive address=0x000001 in a drive having a drive ID=1. A logical address=0x000002 in the volume having the volume ID=1 corresponds to a drive address=0x000001 in a drive having a drive ID=2. A logical address=0x000003 in the volume having the volume ID=1 corresponds to a drive address=0x000002 in the drive having the drive ID=1. Furthermore, a logical address=0x000001 in the volume having the volume ID=2 corresponds to a drive address=0x000003 in the drive having the drive ID=1.

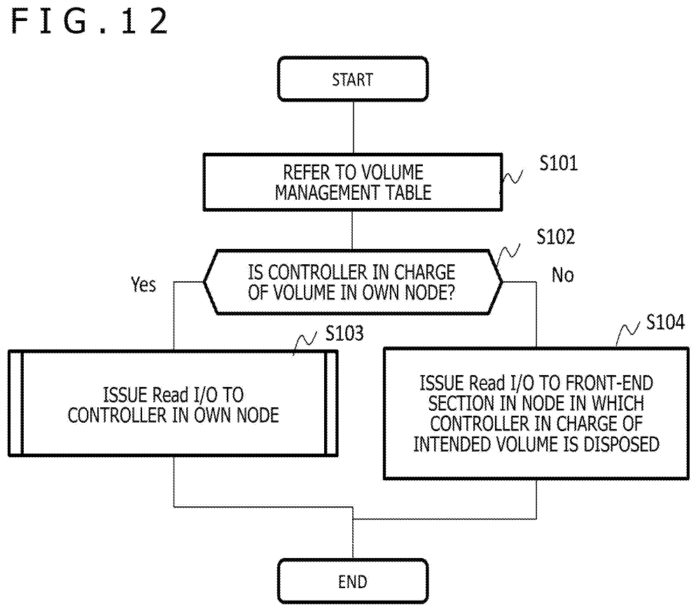

FIG. 12 is a flowchart illustrating data read processing executed by the front-end section. The present processing is processing common to the front-end section 321 in the resource saving node 320 and the front-end section 331 in the highly functional node 330.

The front-end section refers to the volume management table 363 (Step S101). Next, the front-end section determines whether the controller in charge of a volume from which data is to be read is in the own node in which the front-end section is disposed (Step S102). When the controller in charge of the volume is in the own node, the front-end section issues a request of Read I/O to the controller in the own node (Step S103). When the controller in charge is not in the own node, the front-end section issues a request of Read I/O to the front-end section in the storage node in which the controller in charge of the volume from which data is to be read is disposed (Step S104).

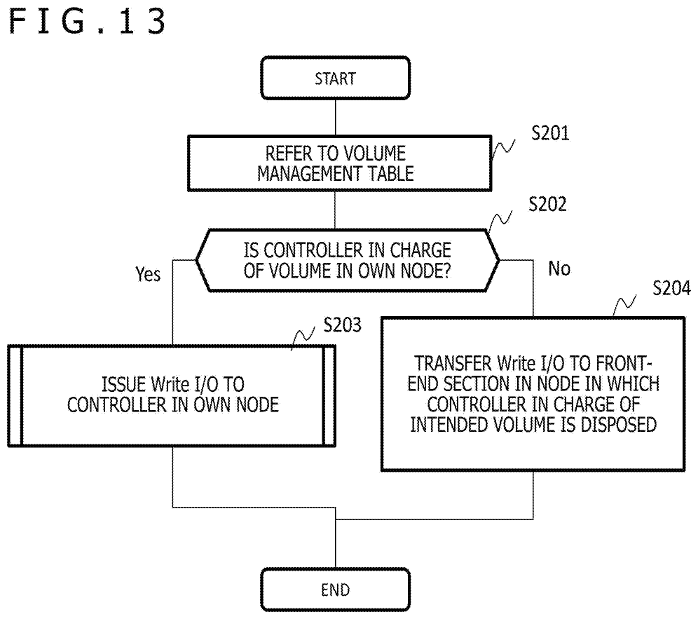

FIG. 13 is a flowchart illustrating data write processing executed by the front-end section. The present processing is processing common to the front-end section 321 in the resource saving node 320 and the front-end section 331 in the highly functional node 330.

The front-end section refers to the volume management table 363 (Step S201). Next, the front-end section determines whether the controller in charge of a volume to which data is to be written is in the own node (Step S202). When the controller in charge of the volume is in the own node, the front-end section issues a request of Write I/O to the controller in the own node (Step S203). When the controller in charge of the volume is not in the own node, the front-end section issues a request of Write I/O to the front-end section in the storage node in which the controller in charge of the volume to which data is to be written is disposed (Step S204).

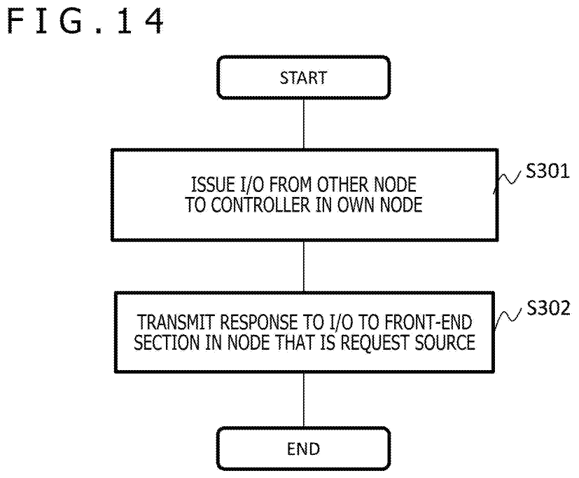

FIG. 14 is a flowchart illustrating processing executed by the front-end section upon receiving a request from the other node. The present processing is processing common to a data read request and a data write request. In addition, the present processing is processing common to the front-end section 321 in the resource saving node 320 and the front-end section 331 in the highly functional node 330.

The front-end section issues the request of Read I/O or request of Write I/O received from the front-end section in the other node to the controller in the own node (Step S301). Next, the front-end section transmits a response to Read I/O or Write I/O received from the controller, to the front-end section in the node that is a request source (Step S302).

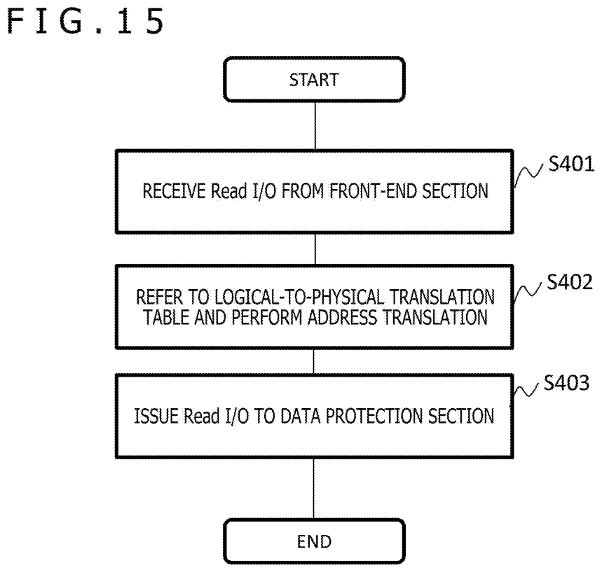

FIG. 15 is a flowchart illustrating data read processing executed by the resource saving controller.

Upon receiving the request of Read I/O from the front-end section 321 in the own node (Step S401), the resource saving controller 322 disposed in the resource saving node 320 refers to the logical-to-physical translation table 364 and translates a logical address from which data is to be read into a physical address (Step S402). Subsequently, the resource saving controller 322 issues a request of Read I/O to the data protection section 323 in the own node (Step S403). While an example in which the logical address differs from the physical address and address translation is performed is described in the present embodiment, the present invention is not limited to the example. As another example, in a case of applying straight mapping in which the logical address is identical to the physical address, address translation processing in Step S402 is unnecessary.

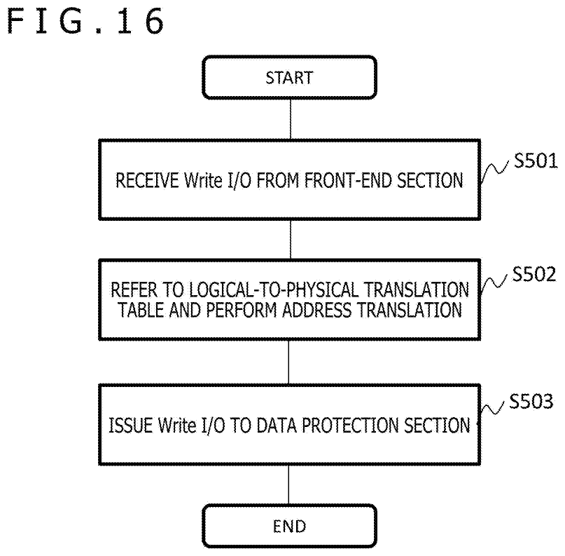

FIG. 16 is a flowchart illustrating data write processing executed by the resource saving controller.

Upon receiving the request of Write I/O from the front-end section 321 in the own node (Step S501), the resource saving controller 322 refers to the logical-to-physical translation table 364 and translates a logical address to which data is to be written into a physical address (Step S502). Subsequently, the resource saving controller 322 issues a request of Write I/O to the data protection section 323 in the own node (Step S503). While the example in which the logical address differs from the physical address and address translation is performed is described in the present embodiment, the present invention is not limited to the example. As another example, in the case of applying straight mapping in which the logical address is identical to the physical address, address translation processing in Step S502 is unnecessary.

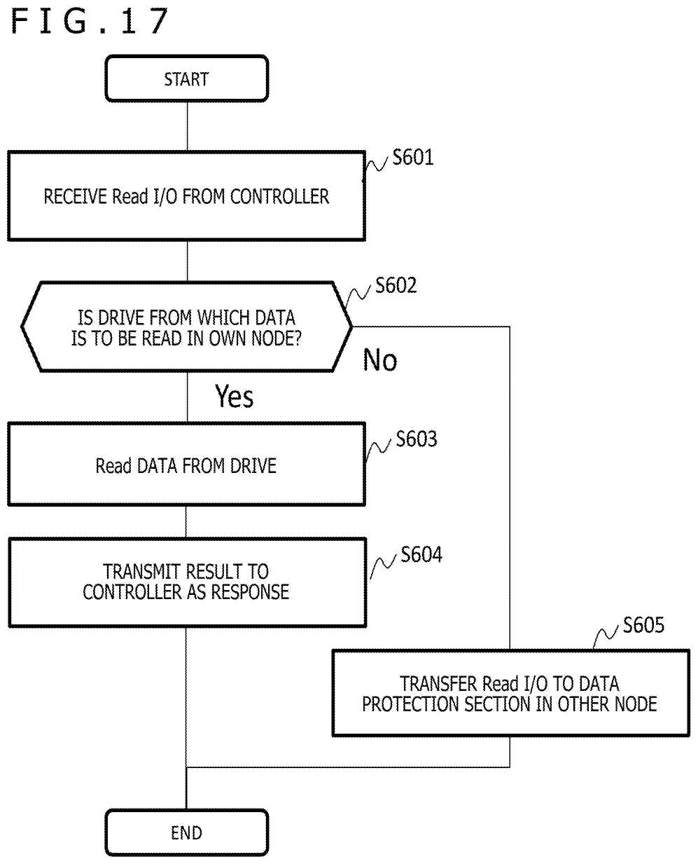

FIG. 17 is a flowchart illustrating data read processing executed by the data protection section. The present processing is processing common to the data protection section 323 in the resource saving node 320 and the data protection section 333 in the highly functional node 330.

Upon receiving the request of Read I/O from the controller in the own node (Step S601), the data protection section determines whether an intended drive 315 from which data is to be read is in the own node (Step S602). When the intended drive 315 is in the own node, the data protection section reads the data from the intended drive 315 (Step S603) and transmits a result to the controller in the own node as a response (Step S604). On the other hand, when the intended drive 315 is not in the own node in Step S602, the data protection section transfers the request of Read I/O to the data protection section in the other node in which the intended drive 315 is disposed (Step S605).

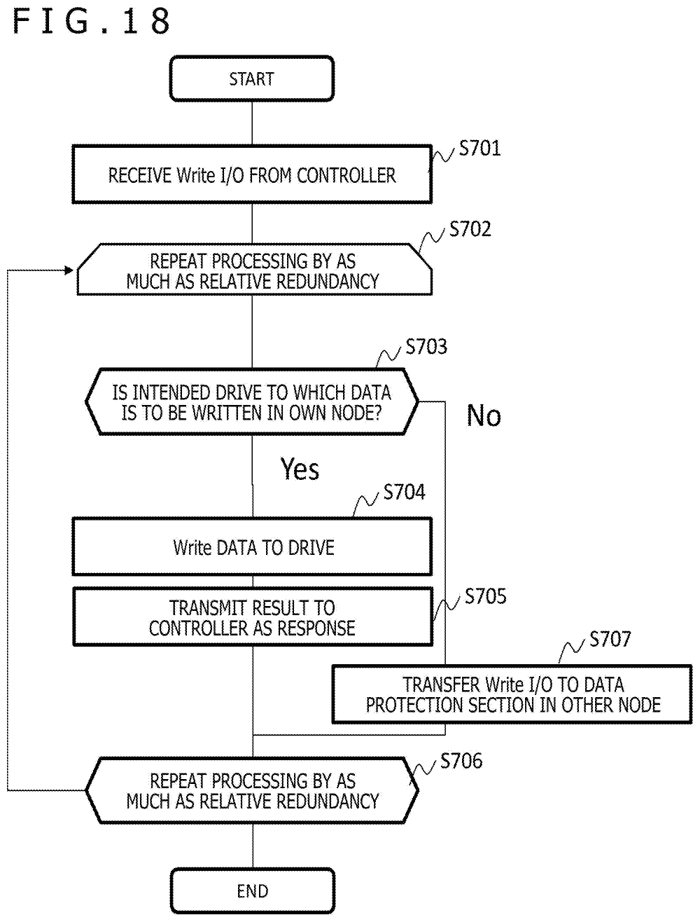

FIG. 18 is a flowchart illustrating data write processing executed by the data protection section. The present processing is processing common to the data protection section 323 in the resource saving node 320 and the data protection section 333 in the highly functional node 330.

The data protection section receives the request of Write I/O from the controller in the own node (Step S701). Subsequently, the data protection section repeatedly performs processing in Steps S702 to S706 by as much as the relative redundancy while changing the intended drives 315 to be processed. For example, when data is redundant and stored in the drives 315 in the two different storage nodes, the data protection section performs the processing in Steps S702 to S706 repeatedly, that is, twice while changing the storage nodes and the intended drives 315 to be processed. In a case of redundancy by Erasure-Coding and RAID, the drive 315 to which updated parity is written is also counted as the relative redundancy.

First, the data protection section determines whether the intended drive 315 to which data is to be written is the drive 315 in the own node (Step S703). When the intended drive 315 is in the own node, the data protection section writes the intended data to the intended drive 315 (Step S704) and transmits a result to the controller in the own node as a response (Step S705). Furthermore, when the intended drive 315 is not in the own node in Step S704, the data protection section transfers the request of Write I/O to the data protection section in the other node in which the intended drive 315 is disposed (Step S707).

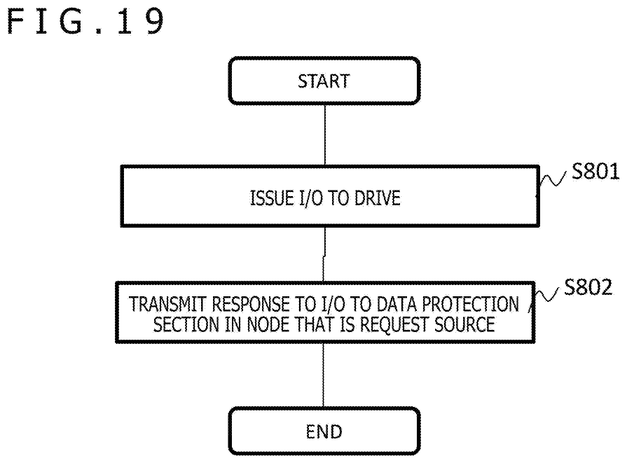

FIG. 19 is a flowchart illustrating processing executed by the data protection section upon receiving a request from the other node. The present processing is processing common to the data read request and the data write request. In addition, the present processing is processing common to the data protection section 323 in the resource saving node 320 and the data protection section 333 in the highly functional node 330.

The data protection section issues the request of Read I/O or request of Write I/O received from the data protection section in the other node to each drive 315 in the own node (Step S801). Next, the data protection section transmits a result of Read I/O or Write I/O received from the drive 315 to the data protection section in the node that is a request source as a response (Step S802).

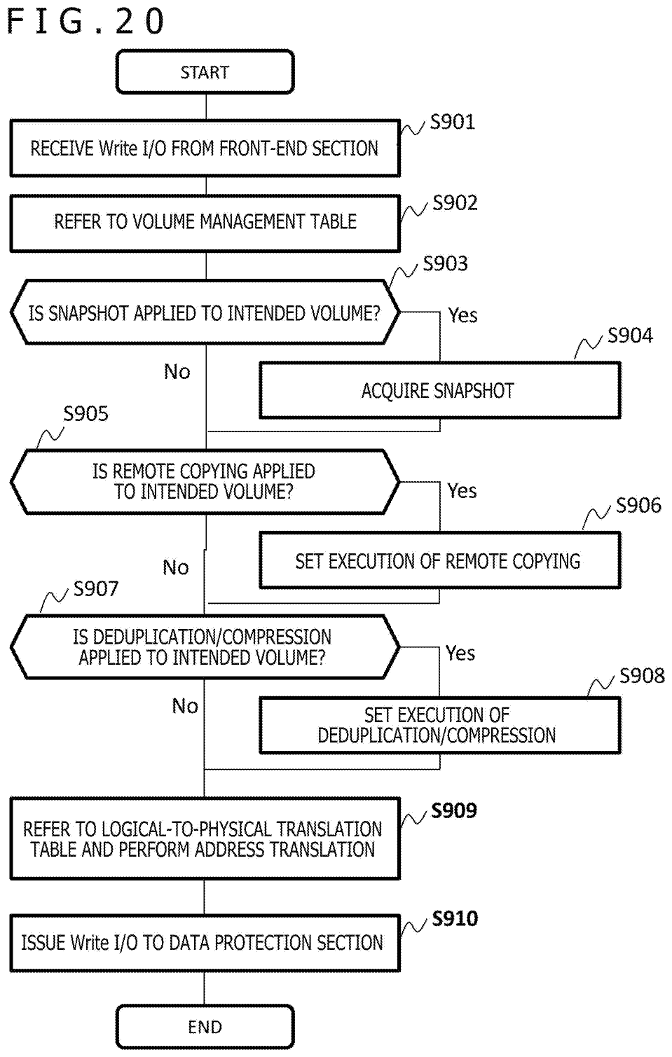

FIG. 20 is a flowchart illustrating data write processing executed by the highly functional controller.

Upon receiving the request of Write I/O from the front-end section 321 in the own node (Step S901), the highly functional controller 332 refers to the volume management table 363 (Step S902).

Subsequently, the highly functional controller 332 determines whether the snapshot function is applied to an intended volume to which data is to be written (Step S903). When the snapshot function is applied to the intended volume, the highly functional controller 332 acquires a snapshot of the intended volume (Step S904). A state of the volume before data is to be written to the volume is thereby stored.

When the snapshot function is not applied to the intended volume or after Step S904, the highly functional controller 332 determines whether the remote copying function is applied to the intended volume to which data is to be written (Step S905). When the remote copying function is applied to the intended volume, the highly functional controller 332 sets execution of remote copying (Step S906). The data to be written is thereby copied to a remote copy destination.

When the remote copying function is not applied to the intended volume in Step S905 or after Step S906, the highly functional controller 332 determines whether the deduplication/compression functions are applied to the intended volume to which data is to be written (Step S907). When the deduplication/compression functions are applied to the intended volume, the highly functional controller 332 sets execution of the deduplication and the compression (Step S908). If the data to be written is already present in another location, a pointer indicating the location where data is present is thereby set to a data write location. Furthermore, in a case of writing data, data is to be compressed and then written.

In a case in which the deduplication/compression functions are not applied to the intended volume in Step S907 or after Step S908, the highly functional controller 332 refers to the logical-to-physical translation table 364 and translates a logical address to which data is to be written into a physical address (Step S909). Subsequently, the highly functional controller 332 issues a request of Write I/O to the data protection section 333 in the own node (Step S910). While the example in which the logical address differs from the physical address and address translation is performed is described in the present embodiment, the present invention is not limited to the example. As another example, in the case of applying straight mapping in which the logical address is identical to the physical address, address translation processing in Step S909 is unnecessary.

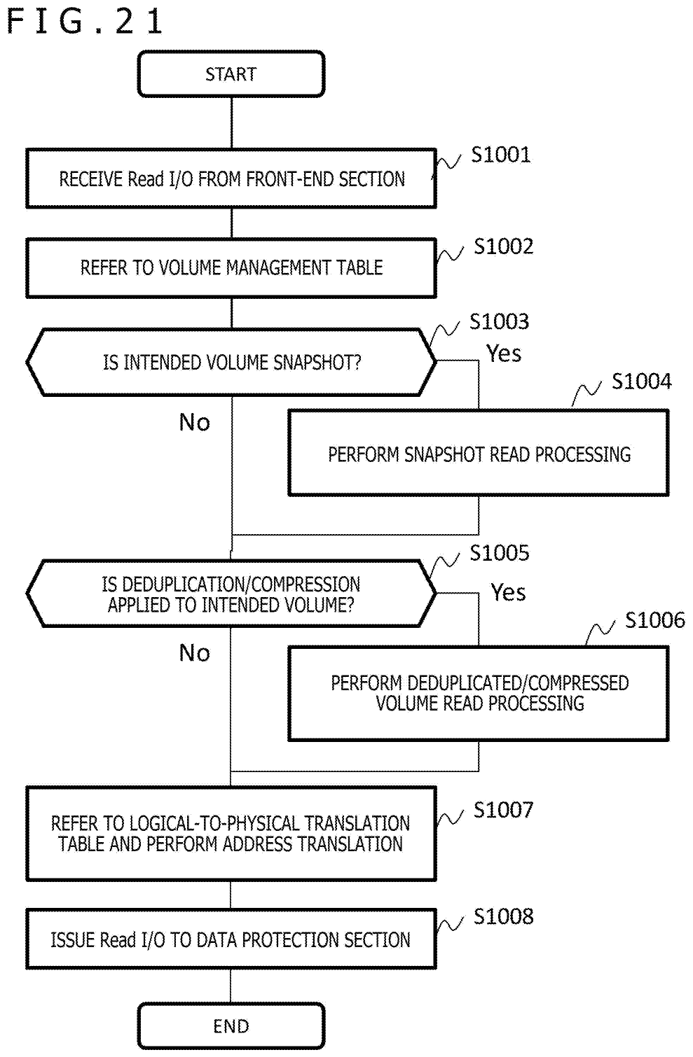

FIG. 21 is a flowchart illustrating data read processing executed by the highly functional controller.

Upon receiving the request of Read I/O from the front-end section 321 in the own node (Step S1001), the highly functional controller 332 refers to the volume management table 363 (Step S1002).

Next, the highly functional controller 332 determines whether an intended volume from which data is to be read is a snapshot (Step S1003). In a case in which the intended volume is a snapshot, the highly functional controller 332 determines whether to read data from an original volume corresponding to the snapshot as snapshot read processing (Step S1004).

In a case in which the intended volume is not a snapshot in Step S1003 or after Step S1004, the highly functional controller 332 determines whether the deduplication/compression functions are applied to the intended volume from which data is to be read (Step S1005). In a case in which the deduplication/compression functions are applied to the intended volume, the highly functional controller 332 performs deduplicated/compressed volume read processing (Step S1006). When a location where data is present is indicated by a pointer by the deduplication function, the location indicated by the pointer is a location where data is to be read. When data compressed by the compression function is recorded, setting is made such that read data is decompressed.

In a case in which the deduplication/compression functions are not applied to the intended volume in Step S1005 or after Step S1006, the highly functional controller 332 refers to the logical-to-physical translation table 364 and translates a logical address from which data is to be read into a physical address (Step S1007). Subsequently, the highly functional controller 332 issues a request of Read I/O to the data protection section 333 in the own node (Step S1008). While the example in which the logical address differs from the physical address and address translation is performed is described in the present embodiment, the present invention is not limited to the example. As another example, in the case of applying straight mapping in which the logical address is identical to the physical address, address translation processing in Step S1007 is unnecessary.

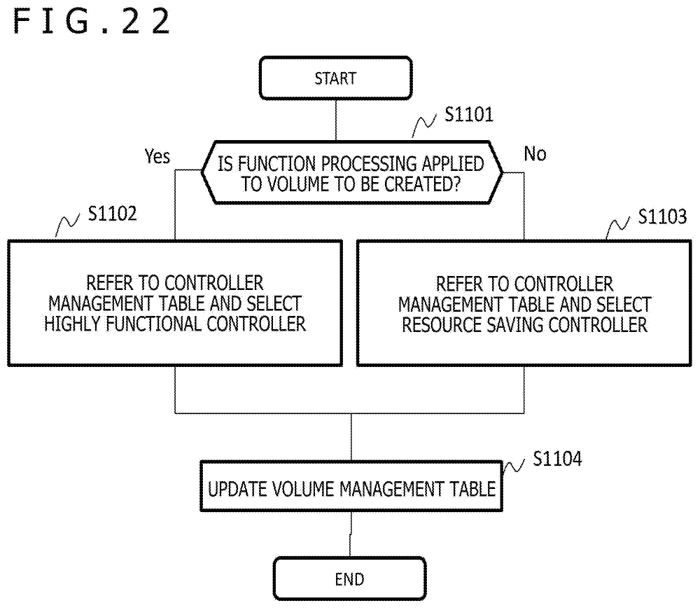

FIG. 22 is a flowchart illustrating volume creation processing executed by the configuration management section. The volume creation processing is processing for creating a new volume in the storage system. The configuration management section 325 executes the volume creation processing in accordance with an instruction from the administrator via the management terminal 200.

The configuration management section 325 determines whether to apply function processing to a volume to be created on the basis of an administrator's designation (Step S1101). In a case of applying function processing to the volume to be created, the configuration management section 325 refers to the controller management table 362 and selects any of the highly functional controllers 332 as a controller in charge of the volume to be created (Step S1102). In a case of not applying function processing to the volume to be created, the configuration management section 325 refers to the controller management table 362 and selects any of the resource saving controllers 322 as a controller in charge of the volume to be created (Step S1103). Furthermore, the configuration management section 325 sets a volume ID of the volume to be created, whether to apply each function processing to the volume, and a controller ID of the controller in charge of the volume to be created, to the volume management table 363 (Step S1104).

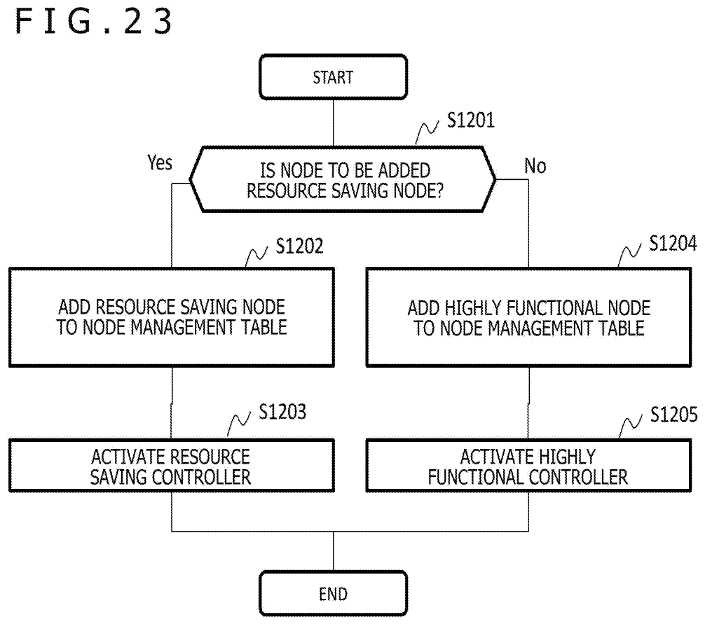

FIG. 23 is a flowchart illustrating storage node addition processing executed by the configuration management section. The storage node addition processing is processing for adding a new storage node to the storage system. The configuration management section 325 executes the storage node addition processing in accordance with an instruction from the administrator via the management terminal 200.

The configuration management section 325 determines whether a storage node to be added is the resource saving node 320 on the basis of an administrator's designation (Step S1201).

In a case in which the storage node to be added is the resource saving node 320, the configuration management section 325 adds a resource saving node 320 to the node management table 361 (Step S1202). Furthermore, the configuration management section 325 constructs a resource saving controller 322 on the added resource saving node 320 and activates the resource saving controller 322 (Step S1203). At this time, the configuration management section 325 sets information about the new resource saving controller 322 to the controller management table 362.

On the other hand, in a case in which the storage node to be added is not the resource saving node 320, the configuration management section 325 adds a highly functional node 330 to the node management table 361 (Step S1204). Moreover, the configuration management section 325 constructs a highly functional controller 332 on the added highly functional node 330 and activates the highly functional controller 332 (Step S1204). At this time, the configuration management section 325 sets information about the new highly functional controller 332 to the controller management table 362.

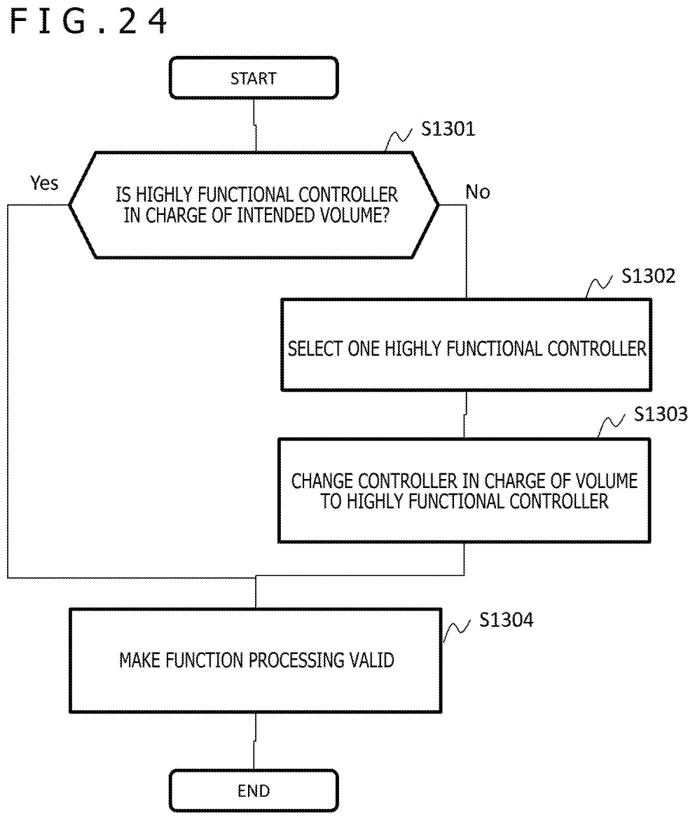

FIG. 24 is a flowchart illustrating processing for applying function processing to a volume, executed by the configuration management section. The processing for applying function processing to a volume is processing for starting to apply function processing to the existing volume to which function processing is not applied. The configuration management section 325 executes the processing for applying function processing to the volume in accordance with an administrator's instruction via the management terminal 200.

The configuration management section 325 refers to the volume management table 363 and determines whether the storage controller in charge of an intended volume to which the function processing designated by the administrator is to be applied is the highly functional controller 332 (Step S1301). In a case in which the storage controller in charge of the intended volume is not the highly functional controller 332, the configuration management section 325 refers to the controller management table 362 and selects one highly functional controller 332 (Step S1301). Furthermore, the configuration management section 325 changes the controller in charge of the intended volume to the selected highly functional controller 332 (Step S1303). At this time, the configuration management section 325 updates a box of the controller in charge in the volume management table 363.

In a case in which the controller in charge of the intended volume is the highly functional controller 332 in Step S1301 or after Step S1303, the configuration management section 325 starts to apply function processing to the intended volume (Step S1304). At this time, the configuration management section 325 updates one or two boxes of any of the snapshot, the remote copying, and the deduplication/compression, or all boxes thereof from “not applied” to “applied.”

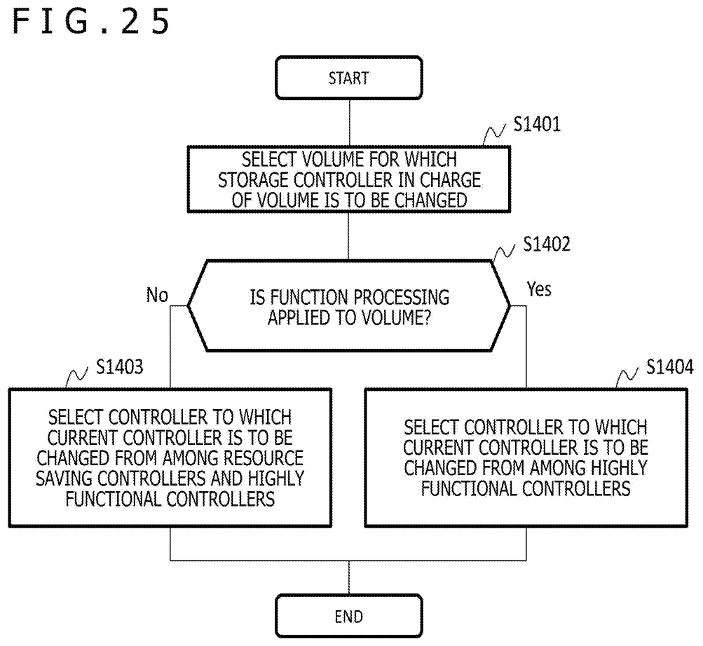

FIG. 25 is a flowchart illustrating processing for determining a storage controller to which a storage controller currently in charge of a volume is to be changed, executed by the configuration management section. The processing for determining a storage controller to which a storage controller currently in charge of a volume is to be changed is carried out for, for example, reducing an imbalance when there is the imbalance in volumes of which a plurality of storage controllers take charge. The configuration management section 325 executes the processing for determining a storage controller to which a storage controller currently in charge of a volume in accordance with an administrator's instruction via the management terminal 200.

The configuration management section 325 selects a volume for which the storage controller in charge of the volume is to be changed on the basis of an administrator's designation (Step S1401). Subsequently, the configuration management section 325 refers to the volume management table 363 and determines whether function processing is applied to the selected volume (Step S1402).

While the resource saving controller 322 is incapable of taking charge of a volume to which function processing is to be applied, the highly functional controller 332 is capable of taking charge of a volume to which function processing is not applied.

In a case in which function processing is not applied to the selected volume, the configuration management section 325 selects a storage controller newly in charge of the selected volume from among the resource saving controllers 322 and the highly functional controllers 332 registered in the controller management table 362 (Step S1403). At this time, the configuration management section 325 may calculate, for example, a load of each storage controller as an index and select the storage controller having a lightest load. Alternatively, the configuration management section 325 may use a load of each CPU core as an index or use another index.

On the other hand, in a case in which function processing is applied to the selected volume, the configuration management section 325 selects a storage controller newly in charge of the selected volume from among the highly functional controllers 332 registered in the controller management table 362 (Step S1404). At this time, the configuration management section 325 may calculate, for example, the load of each storage controller as an index and select the storage controller having the lightest load. Alternatively, the configuration management section 325 may use the load of each CPU core as an index or use another index.

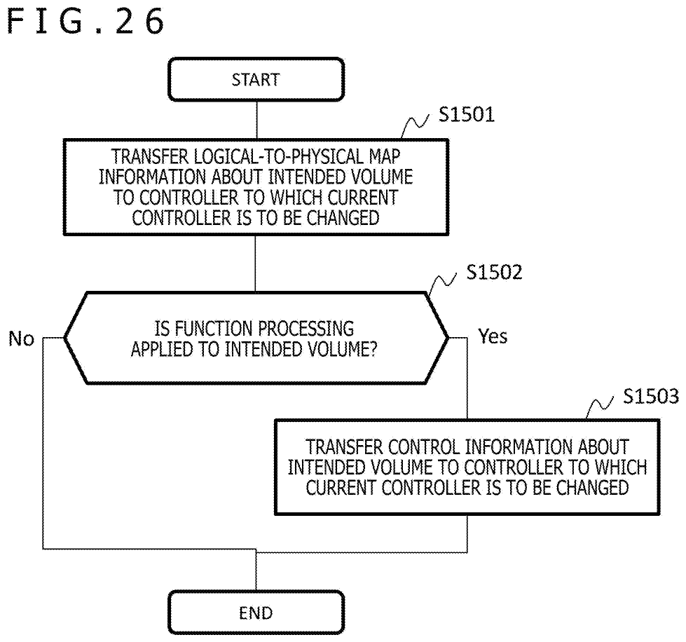

FIG. 26 is a flowchart illustrating processing for changing a storage controller in charge of a volume, executed by the configuration management section. The processing for changing a storage controller in charge of a volume is executed, for example, when a change destination that is the storage controller to which the storage controller currently in charge of the volume is to be changed is determined by, for example, the processing of FIG. 25 and then the storage controller currently in charge of the volume is actually changed to the determined storage controller. The configuration management section 325 executes the processing for changing a storage controller in charge of a volume in accordance with an administrator's instruction via the management terminal 200.

The configuration management section 325 extracts a part associated with the intended volume from the logical-to-physical translation table 364 owned by the storage controller currently in charge of the intended volume, and transfers the extracted part to the change destination that is the storage controller to which the current storage controller is to be changed. Subsequently, the configuration management section 325 refers to the volume management table 363 and determines whether function processing is applied to the intended volume (Step S1502). In a case in which function processing is applied to the intended volume, the configuration management section 325 extracts part associated with the intended volume from the control information 352 owned by the highly functional controller 332 currently in charge of the intended volume, and transfers the extracted part to the change destination that is the highly functional controller 332 to which the current highly functional controller 332 is to be changed.

As described so far, in the present embodiment, a storage system has: a first storage node (resource saving controller 322) including a first controller (resource saving controller 322) that controls input/output processing for writing data to a storage area (volume) provided by a storage device (drive 315) or reading data from the storage area; a second storage node (highly functional node 330) including a second controller (highly functional controller 332) that controls the input/output processing and function processing associated with data stored in the storage device; and a configuration management section that causes the first controller or the second controller selected on the basis of whether function processing is applied to the one or more storage area to take charge of control over the storage area. In this way, the second controller that can handle the function processing requiring resources and the first controller intended to achieve resource saving by omitting the function processing are prepared and the second controller and the first controller are used depending on whether function processing is applied to the storage area; thus, it is possible to make effective use of resources of the storage system.

Furthermore, in the present embodiment, the configuration management section 325 sets, as storage areas, a first storage area to which function processing is not applied and a second storage area to which function processing is applied, causes the first controller to take charge of the first storage area and the second controller to take charge of the second storage area. In this way, in the storage system in which whether to apply the function processing is set to each storage area, the storage area to which the function processing is not applied and the storage area to which the function processing is applied are provided, and a suited controller is allowed to take charge of each of the storage areas, thereby making it possible to make effective use of the resources of the storage system.

Moreover, in the present embodiment, the configuration management section 325 sets the first storage area in the storage device in the first storage node, and sets the second storage area in the storage device in the second storage node. In this way, the first controller and the first storage area of which the first controller takes charge are disposed together in the first storage node, and the second controller and the second storage area of which the second controller take charge are disposed together in the second storage node; thus, each controller is capable of efficiently processing the storage area of which the controller takes charge in the node.

Furthermore, in the present embodiment, each of the first storage node and the second storage node further includes a front-end section that serves as an interface with a host connected to the storage system, the front-end section in the first storage node transfers a request of the function processing to the front-end section in the second storage node, and the front-end section in the second storage node issues a request of the function processing to the second controller in an own node in which the front-end section is disposed upon receiving the transferred request of the function processing. In this way, the function processing received by the first storage node from which the function processing is omitted is transferred to the second storage node capable of handling the function processing; thus, the host is capable of using the storage system without knowledge of a difference between the first storage node and the second storage node.

Moreover, in the present embodiment, the storage system is capable of realizing data redundancy by a plurality of storage devices, each of the first storage node and the second storage node further includes a data protection section (323, 333) that executes processing on the plurality of storage devices in accordance with a request from the controller, the data protection section transfers the request to the data protection section in the other node in a case in which an object subjected to the requested input/output processing or function processing includes the storage device in the other node, and executes the input/output processing or the function processing on the storage device that is the object subjected to the requested processing in the own node and transmits a result to the data protection section from which the request is transferred as a response to the request when the request is transferred from the data protection section in the other node. In this way, the data protection section realizing data redundancy is capable of transferring the input/output processing and the function processing to the other node and the input/output processing and the function processing can be executed in the other node. For example, when the controller in charge of the storage area is to be changed, the data protection section in the node, in which the controller to which the controller currently in charge of the storage area is to be changed is disposed, transfers a request to the data protection section in the node in which the original controller in charge of the storage area is disposed. It is thereby possible to realize change of the controller in charge of the storage area without moving data between the storage devices. Since the storage area to which the function processing is not applied is thereby changed to the storage area to which the function processing is applied, it is possible to realize change of the controller in charge of the storage area from the first controller to the second controller without moving the data between the storage devices.

Furthermore, in the present embodiment, a plurality of first controllers are each duplexed, one or more second controllers are each duplexed, an active controller to which one first controller is duplexed and a standby controller to which the one first controller is duplexed are disposed in different first storage nodes, the active controller to which the one first controller is duplexed and a standby controller to which the other first controller is duplexed are disposed in the same first storage node, an active controller to which one second controller is duplexed and a standby controller to which the one second controller is duplexed are disposed in different second storage nodes, and the other second controllers are not disposed in the second storage node in which the active controller to which the one second controller is duplexed is disposed and the second storage node in which the standby controller to which the one second controller is duplexed is disposed. In this way, duplexing each of the first controller having relatively small resources and the second controller having relatively ample resources makes it possible to efficiently configure the storage system striking a balance of resources and having the redundant controllers.

Moreover, in the present embodiment, the configuration management section manages a storage area management table (volume management table 363) that makes each storage area correspond to whether to apply the function processing to the storage area and the controller in charge of the storage area, and changes the controller in charge of the storage area to which function processing is not applied to the second controller in a case in which the first controller takes charge of the storage area at a time of starting to apply the function processing to the storage area. It is thereby possible to make effective use of the resources of the storage system in which whether to apply the function processing is set to each storage area, and apply the function processing to the storage area to which the function processing is not applied ex-post facto.

### Second Embodiment

In the first embodiment, an example in which the compute nodes 100 each serving as a host computer and using the storage system are provided independently has been described, as depicted in FIG. 1. However, the embodiments are not limited to the configurations. As another example, a device corresponding to a host computer may be provided in a resource saving node.

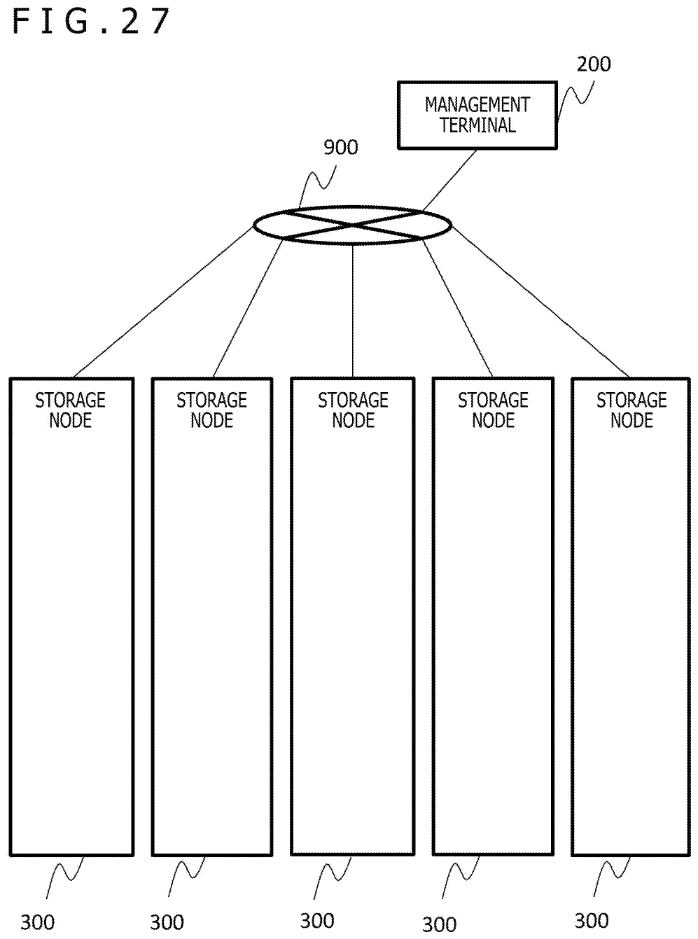

FIG. 27 is a block diagram depicting an example of configurations of a storage system according to a second embodiment. In the storage system according to the second embodiment, the management terminal 200 and the storage nodes 300 are connected to the communication network 900. The devices mutually connected via the communication network 900 can hold communication with one another as appropriate. The storage system according to the second embodiment differs from that according to the first embodiment depicted in FIG. 1 in that the compute nodes 100 are not present.

The management terminal 200 according to the second embodiment is similar to that according to the first embodiment depicted in FIG. 1. Each storage node 300 according to the second embodiment is similar to that according to the first embodiment in that the storage node 300 can be implemented as either the resource saving node 320 or the highly functional node 330. While the highly functional node 330 according to the second embodiment is similar to that according to the first embodiment, the resource saving node 320 according to the second embodiment differs from that according to the first embodiment.

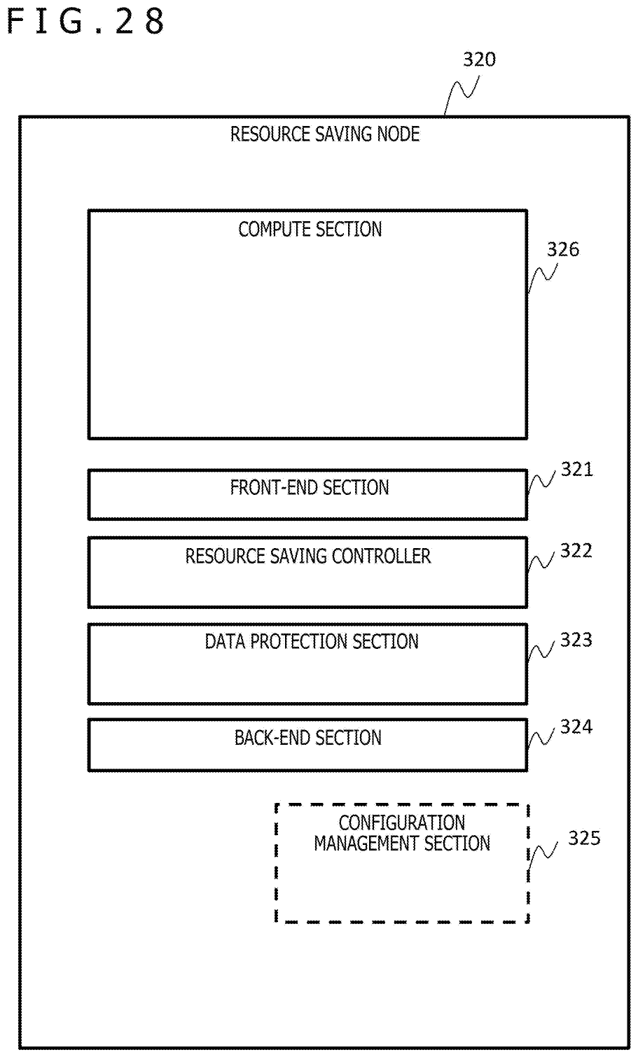

FIG. 28 is a block diagram depicting software configurations of the resource saving node according to the second embodiment. The resource saving node 320 according to the second embodiment has the front-end section 321, the resource saving controller 322, the data protection section 323, the back-end section 324, the configuration management section 325, and a compute section 326. The front-end section 321, the resource saving controller 322, the data protection section 323, the back-end section 324, the configuration management section 325, and the compute section 326 are software programs implemented in the storage node 300.

The front-end section 321, the resource saving controller 322, the data protection section 323, the back-end section 324, and the configuration management section 325 are similar to those according to the first embodiment depicted in FIG. 3.

The compute section 326 corresponds to the compute node 100 according to the first embodiment, and is software that serves as a host computer and that performs user's desired calculation using the storage system.

As described so far, according to the present embodiment, the first storage node (resource saving node 320) has the compute section 326 that issues a request of processing to the storage system; thus, it is possible to efficiently construct a system by disposing a host in the first storage node.

### Third Embodiment

In the first embodiment, an example in which the storage devices (drives 315) are mounted in each storage node 300 has been described, as depicted in FIG. 2. However, the embodiments are not limited to the configurations. As another example, the storage devices may be provided as separate devices from the storage nodes.

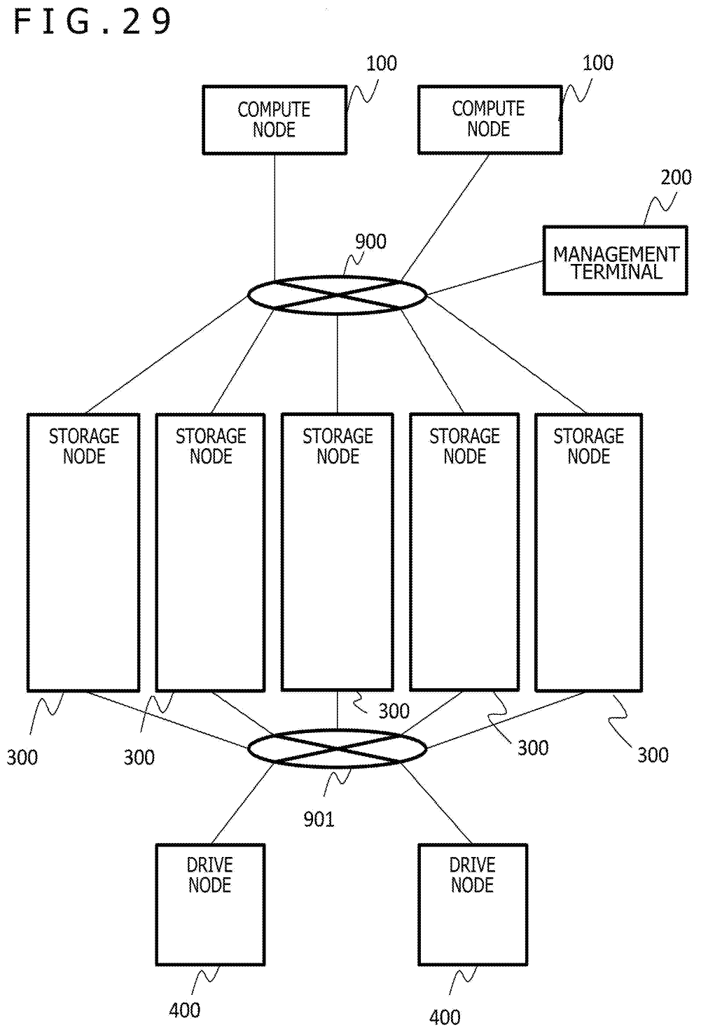

FIG. 29 is a block diagram depicting an example of configurations of a storage system according to a third embodiment. In the storage system according to the third embodiment, the compute nodes 100, the management terminal 200, and the storage nodes 300 are connected to the communication network 900. The devices mutually connected via the communication network 900 can hold communication with one another as appropriate. Furthermore, each storage node 300 and each drive node 400 are connected to each other via a communication network 901. The devices mutually connected via the communication network 901 can hold communication with one another as appropriate.

The compute nodes 100 and the management terminal 200 according to the third embodiment are similar to those according to the first embodiment depicted in FIG. 1. The storage nodes 300 according to the third embodiment differ from those according to the first embodiment depicted in FIG. 2. Functions of each storage node 300 according to the first embodiment are physically divided into the storage node 300 and the drive node 400, each of the storage node 300 and the drive node 400 is a device having a casing.

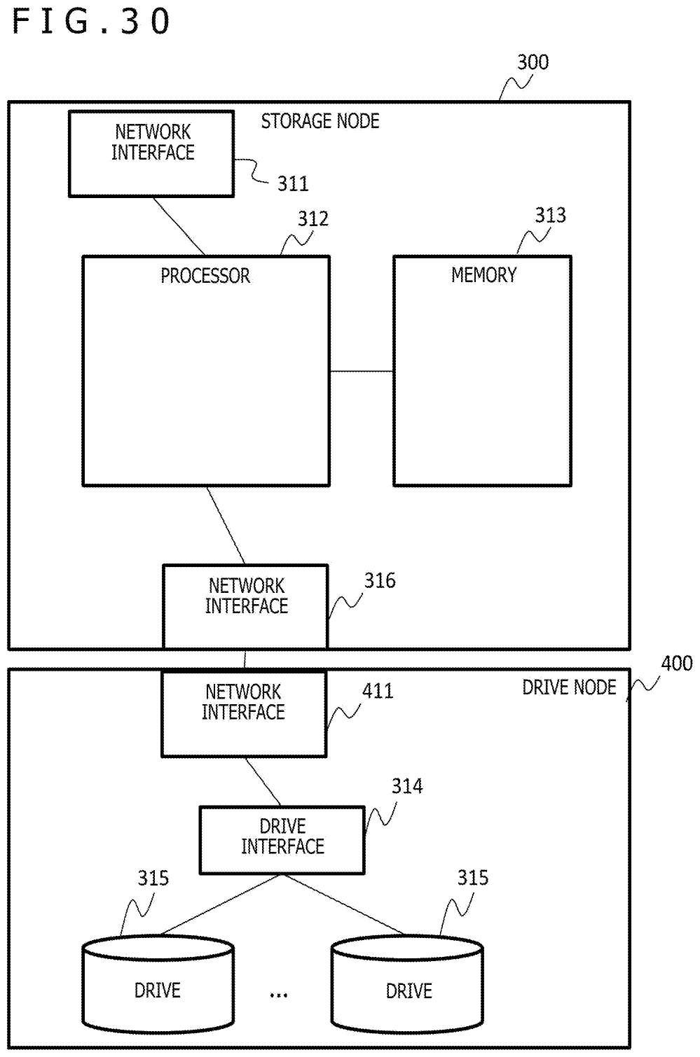

FIG. 30 is a block diagram depicting hardware configurations of the storage node and the drive node according to the third embodiment. The storage node 300 has the network interface 311, the processor 312, the memory 313, and a network interface 316. The drive node 400 has a network interface 411, the drive interface 314, and the drives 315.

Functions of the network interface 311, the processor 312, the memory 313, the drive interface 314, and the drives 315 are similar to those according to the first embodiment depicted in FIG. 2. The network interfaces 316 and 411 are devices that hold communication via the communication network 901. A plurality of storage nodes 300 can communicate with any of a plurality of drive nodes 400 and share the drives 315 in the plurality of drive nodes 400.

Each storage node 300 according to the third embodiment is similar to that according to the first embodiment in that the storage node 300 can be implemented as either the resource saving node 320 or the highly functional node 330. Software configurations of the resource saving node 320 according to the third embodiment are basically similar to those of the resource saving node 320 according to the first embodiment depicted in FIGS. 3 and 5. Software configurations of the highly functional node 330 according to the third embodiment are basically similar to those of the highly functional node 330 according to the first embodiment depicted in FIGS. 4 and 6.

The processor 312 in the storage node 300 writes data to each drive 315 in the drive node 400 and reads data from the drive 315 in the drive node 400 via the network interfaces 316 and 411.

As described so far, in the present embodiment, the storage system has the drive node 400, the drive node 400 has the storage devices (drives 315), and each of the first storage nodes (resource saving nodes 320) and the second storage nodes (highly functional nodes 330) can write data to the storage devices and read data from the storage devices. Since the drive node separated from the first storage nodes and the second storage nodes provides storage capacities of the storage devices to both of the first storage nodes and the second storage nodes, it is possible to construct a storage system having flexible configurations.

### Fourth Embodiment

While an example of providing two types of the resource saving controller 322 and the highly functional controller 332 as the storage controller classes has been described in the first embodiment, the embodiments are not limited to this example. As another example, three or more types of storage controllers may be provided. As a fourth embodiment, an example of providing four types of storage controllers will be described herein. The four types of storage controllers will be referred to as a “first controller,” a “second controller,” a “third controller,” and a “fourth controller.” Details of each storage controller will be described later.

System configurations of a storage system according to the fourth embodiment are similar to those according to the first embodiment depicted in FIG. 1. In addition, hardware configurations of each storage node 300 according to the fourth embodiment are similar to those according to the first embodiment depicted in FIG. 2.

While the resource saving nodes 320 each having the resource saving controller 322 implemented therein as depicted in FIG. 3 and the highly functional nodes 330 each having the highly functional controller 332 implemented therein as depicted in FIG. 4 are provided in the first embodiment, first to fourth nodes having the first to fourth controllers implemented therein are provided, respectively in the fourth embodiment. The first to fourth nodes according to the fourth embodiment each have a front-end section, a data protection section, a back-end section, and the configuration management section 325 similarly to the storage nodes depicted in FIGS. 3 and 4, in addition to the first to fourth controllers.

The configuration management section 325 according to the fourth embodiment has a controller class management table 365 in addition to the node management table 361, the controller management table 362, the volume management table 363, and the logical-to-physical translation table 364.

The controller management table 362, the volume management table 363, and the logical-to-physical translation table 364 according to the fourth embodiment are similar to those according to the first embodiment depicted in FIGS. 9, 10, and 11, respectively.

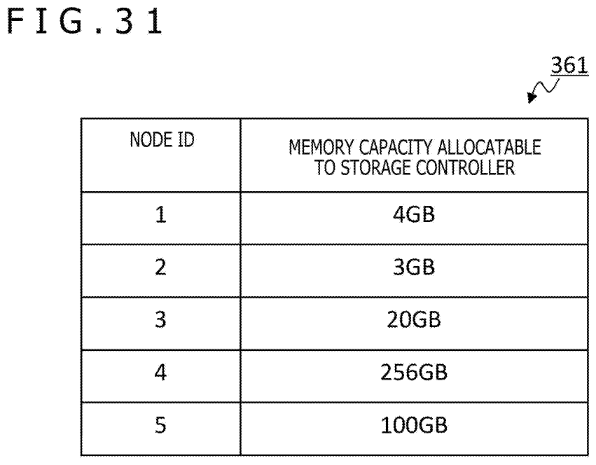

FIG. 31 depicts an example of the node management table according to the fourth embodiment. While the class of each storage node is recorded in the node management table 361 depicted in FIG. 8 according to the first embodiment, the node management table 361 according to the fourth embodiment is a table in which a memory capacity allocatable to the storage controller in each storage node 300 included in the storage system is recorded.

In the example of FIG. 31, there are storage nodes 300 having node IDs=1 to 5. The memory capacity allocatable to the storage controller of the storage node 300 having the node ID=1 is four gigabytes (GB). The memory capacity allocatable to the storage controller of the storage nodes 300 having the node ID=2 is three gigabytes (GB). The memory capacity allocatable to the storage controller of the storage nodes 300 having the node ID=3 is 20 gigabytes (GB). The memory capacity allocatable to the storage controller of the storage nodes 300 having the node ID=4 is 256 gigabytes (GB). The memory capacity allocatable to the storage controller of the storage nodes 300 having the node ID=5 is 100 gigabytes (GB).

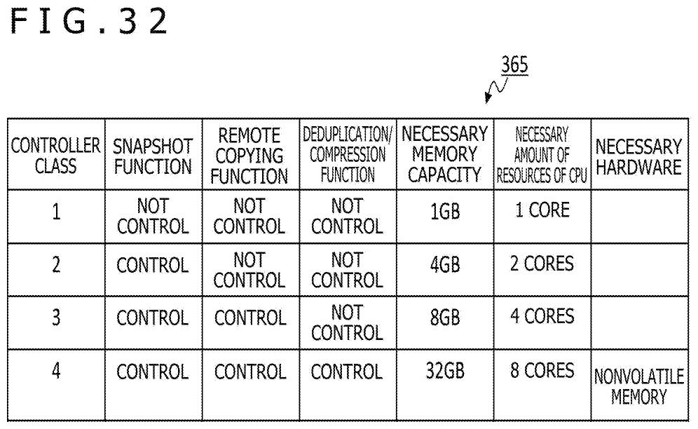

FIG. 32 depicts an example of the controller class management table according to the fourth embodiment. In the controller class management table 365, whether the controller can control each function processing, and a memory capacity, an amount of resources of a CPU, and hardware necessary for the storage controller are recorded per controller class.

For example, the storage controller having a controller class=1 (first controller) does not control any of the function processing, has a necessary memory capacity of one GB, has a necessary amount of resources of the CPU of one core, and has hardware configurations that are not limited to specific configurations. The first controller is the same as the resource saving controller 322 according to the first embodiment in whether the controller can control each function processing.

The storage controller having a controller class=2 (second controller) can control the snapshot function processing, does not control the remote copying function processing and the deduplication/compression function processing, has a necessary memory capacity of four GB, has a necessary amount of resources of the CPU of two cores, and has hardware configurations that are not limited to specific configurations.

The storage controller having a controller class=3 (third controller) can control the snapshot function processing and the remote copying function processing, does not control the deduplication/compression function processing, has a necessary memory capacity of eight GB, has a necessary amount of resources of the CPU of four cores, and has hardware configurations that are not limited to specific configurations.

The storage controller having a controller class=4 (fourth controller) can control all of the snapshot function processing, the remote copying function processing, and the deduplication/compression function processing, has a necessary memory capacity of 32 GB, has a necessary amount of resources of the CPU of eight cores, and needs a nonvolatile memory as hardware configurations. The fourth controller is the same as the highly functional controller 332 according to the first embodiment in whether the controller can control each function processing.

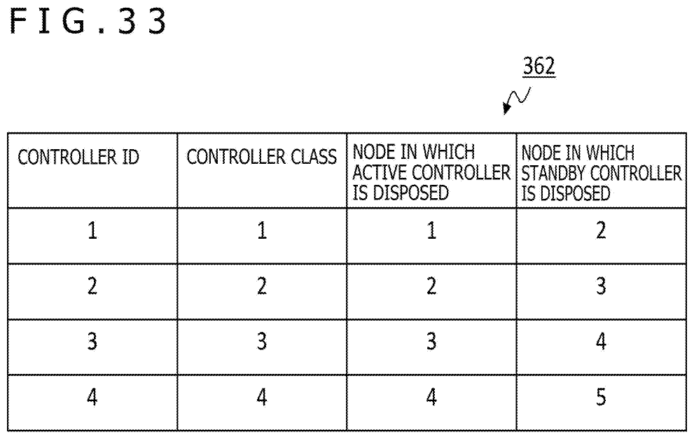

FIG. 33 depicts an example of a controller management table according to the fourth embodiment. As described above, the first to fourth controllers can be set as the controller classes in the controller management table 362 according to the fourth embodiment.

In the example of FIG. 33, the controller having the controller ID=1 is the first controller in the controller class, the active controller having the controller ID=1 is disposed in the storage node 300 having the node ID=1, and the standby controller having the controller ID=1 is disposed in the storage node 300 having the node ID=2. The controller having the controller ID=2 is the second controller in the controller class, the active controller having the controller ID=2 is disposed in the storage node 300 having the node ID=2, and the standby controller having the controller ID=2 is disposed in the storage node 300 having the node ID=3. The controller having the controller ID=3 is the third controller in the controller class, the active controller having the controller ID=3 is disposed in the storage node 300 having the node ID=3, and the standby controller having the controller ID=3 is disposed in the storage node 300 having the node ID=4. The controller having the controller ID=4 is the fourth controller in the controller class, the active controller having the controller ID=4 is disposed in the storage node 300 having the node ID=4, and the standby controller having the controller ID=4 is disposed in the storage node 300 having the node ID=5.

Flowcharts of read processing and write processing executed by the first controller according to the fourth embodiment are similar to those executed by the resource saving controller according to the first embodiment depicted in FIGS. 15 and 16, respectively. Flowcharts of read processing and write processing executed by the fourth controller according to the fourth embodiment are similar to those executed by the highly functional controller according to the first embodiment depicted in FIGS. 20 and 21, respectively.

Furthermore, flowcharts of read processing and write processing executed by the second and third controllers according to the fourth embodiment are similar to those executed by the highly functional controller according to the first embodiment depicted in FIGS. 20 and 21, respectively except for part of the function processing over which the controller is incapable of exercising control. In a case of the second controller, the remote copying function processing and the deduplication/compression function processing are eliminated. In a case of the third controller, the deduplication/compression function processing is eliminated.

Flowcharts of the volume creation processing, the storage node addition processing, and the processing for applying function processing to a volume, the processing for determining a change destination that is a storage controller to which a storage controller currently in charge of the volume is to be changed, and the processing for changing a storage controller in charge of a volume executed by the configuration management section 325 according to the fourth embodiment are basically similar to those according to the first embodiment depicted in FIGS. 21 to 26, respectively. It is to be noted, however, that the flowcharts partially differ from those depicted in FIGS. 21 to 26 because of change of the number of controller classes from two to four.

Furthermore, in the fourth embodiment, possible resources such as the memory capacity allocatable by the storage node to the storage controller are managed using the node management table 361, and necessary resources such as the memory capacity, the amount of resources of the CPU, and the hardware configurations necessary per controller class are managed using the controller class management table 365. It is also assumed that the storage node addition processing is to determine whether possible resources of the storage node to be added satisfy conditions of the necessary resources for a desired storage controller.

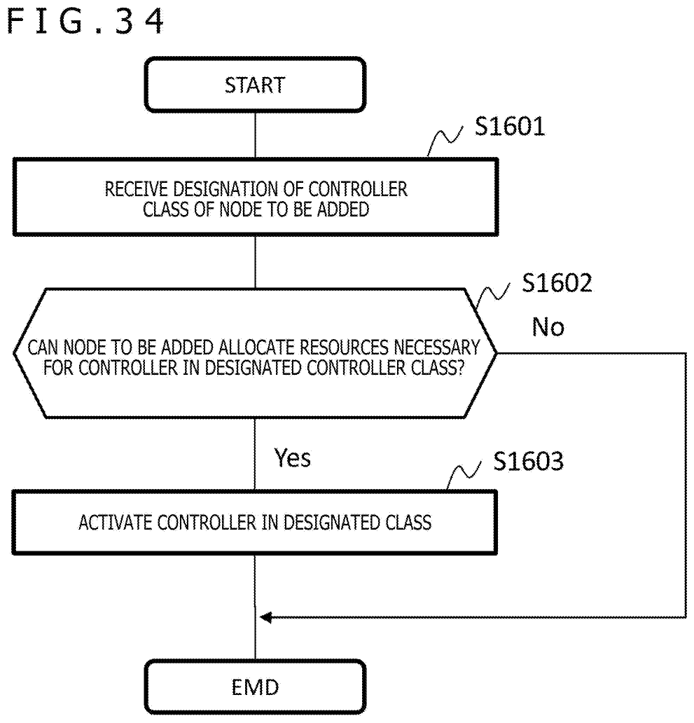

FIG. 34 is a flowchart illustrating the storage node addition processing executed by the configuration management section according to the fourth embodiment.

The configuration management section 325 acquires the class of a storage controller to be added to the storage system from the administrator (Step S1601). Subsequently, the configuration management section 325 refers to the controller class management table 365 and determines whether the storage node to be added can allocate resources necessary for the storage controller in the designated class (Step S1602). In a case in which the storage node to be added to the storage system is capable of allocating resources necessary for the storage controller in the designated class, the configuration management section 325 activates the storage controller in the designated controller class on the added storage node (Step S1603). In a case in which the storage node to be added to the storage system is incapable of allocating resources necessary for the storage controller in the designated class, the configuration management section 325 takes other measures (not depicted).

As described so far, according to the present embodiment, the configuration management section 325 manages the amount of resources necessary for each of a plurality of controller classes, determines whether a new storage node has the amount of resources necessary for a controller in the designated controller class at a time of adding the new storage node, and sets the controller in the designated controller class on the new storage node in a case in which the new storage node has the necessary amount of resources. The administrator can thereby designate a controller class at the time of adding a new storage node, and set a storage controller upon confirming that the new storage node has the amount of resources necessary for the storage controller in the class.

### Fifth Embodiment

While an example in which each of the resource saving node 320 and the highly functional node 330 is realized by a general-purpose computer as depicted in FIG. 2 as the hardware configurations has been described in the first embodiment, the embodiments are not limited to this example. As another example, a storage array device dedicated to the storage system may be used in one or more storage nodes in the storage system. In a fifth embodiment, configurations of using the storage array device in hardware of the highly functional node 330 that actuates the highly functional controller 332 will be exemplarily described.

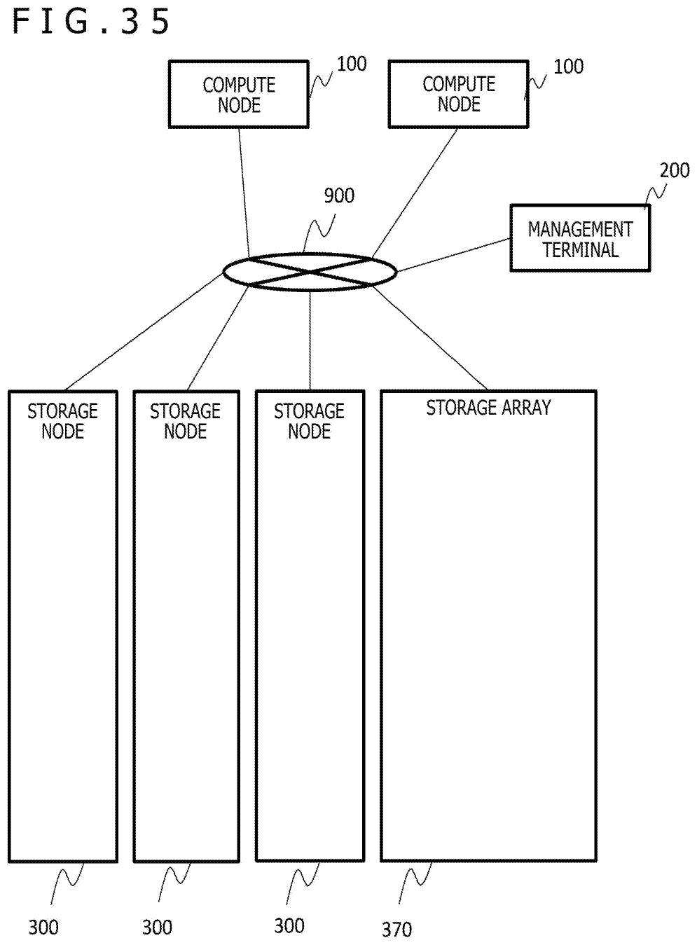

FIG. 35 is a block diagram depicting system configurations of a storage system according to the fifth embodiment. In the storage system according to the fifth embodiment, the compute nodes 100, the management terminal 200, the storage nodes 300, and a storage array 370 are connected to the communication network 900. The compute nodes 100, the management terminal 200, and the storage nodes 300 according to the fifth embodiment are similar to those according to the first embodiment depicted in FIG. 1. The storage array 370 is a computer used for a storage system and having dual processors and the storage devices. Details of the storage array 370 will be described later.

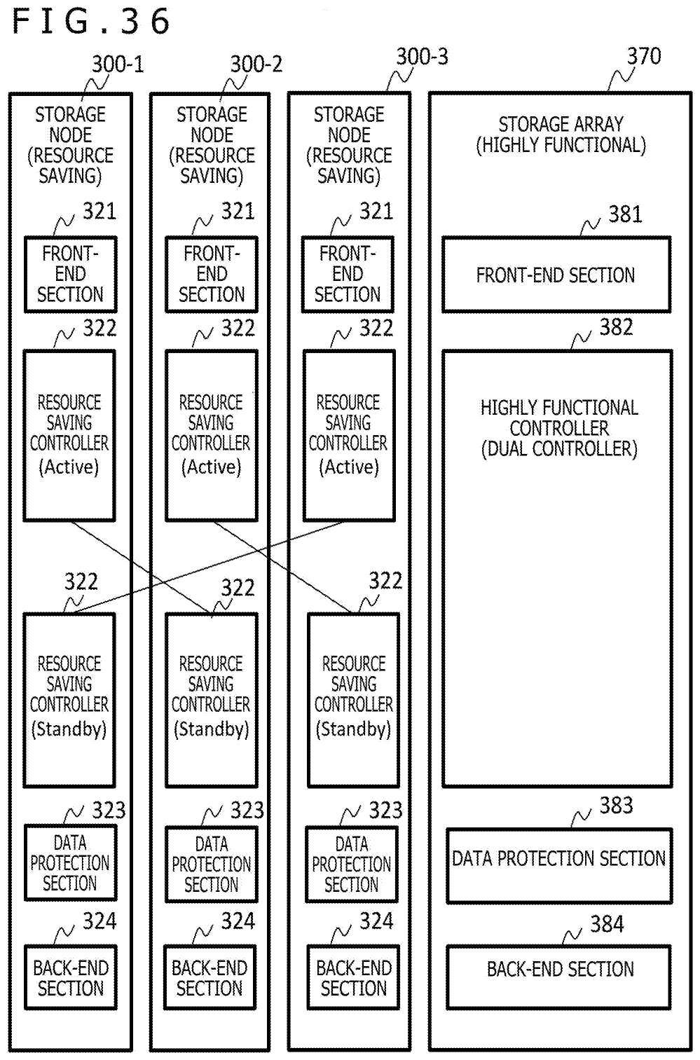

FIG. 36 depicts an example of configurations of a storage system using the storage array device. The storage nodes 300-1 to 300-3 are similar to those according to the first embodiment depicted in FIG. 7.

The storage array 370 has a front-end section 381, a highly functional controller 382, a data protection section 383, and a back-end section 384.

The front-end section 381, which is an interface with each compute node 100, issues a request and a response, and transmits and receives data, similarly to the front-end section 331 according to the first embodiment depicted in FIG. 4.

The highly functional controller 382 controls execution of the basic input/output processing for writing data to each storage device and reading data from the storage device in response to a request from each compute node 100, and the function processing for managing data on the storage device, similarly to the highly functional controller 332 according to the first embodiment depicted in FIG. 4. Furthermore, the highly functional controller 382 may have the configuration management section that manages the configurations of the overall storage system, similarly to the highly functional controller 332 according to the first embodiment. On the other hand, the fifth embodiment differs from the first embodiment in redundant configurations of the highly functional controller. In the first embodiment, the redundancy is obtained by the highly functional controllers 332 on the two storage nodes 300-4 and 300-5. In the fifth embodiment, by contrast, the highly functional controller 382 has redundancy by two storage controllers.

The data protection section 383 makes redundant the data in each storage device at a predetermined relative redundancy, and executes input of data to the storage device and output of data from the storage device. As the redundancy, the same data is stored in a plurality of storage devices, and the number of storage devices storing the same data signifies herein the relative redundancy.

The back-end section 384, which is an interface with each storage device, relays the data written to the storage device and the data read from the storage device to the data protection section 383.

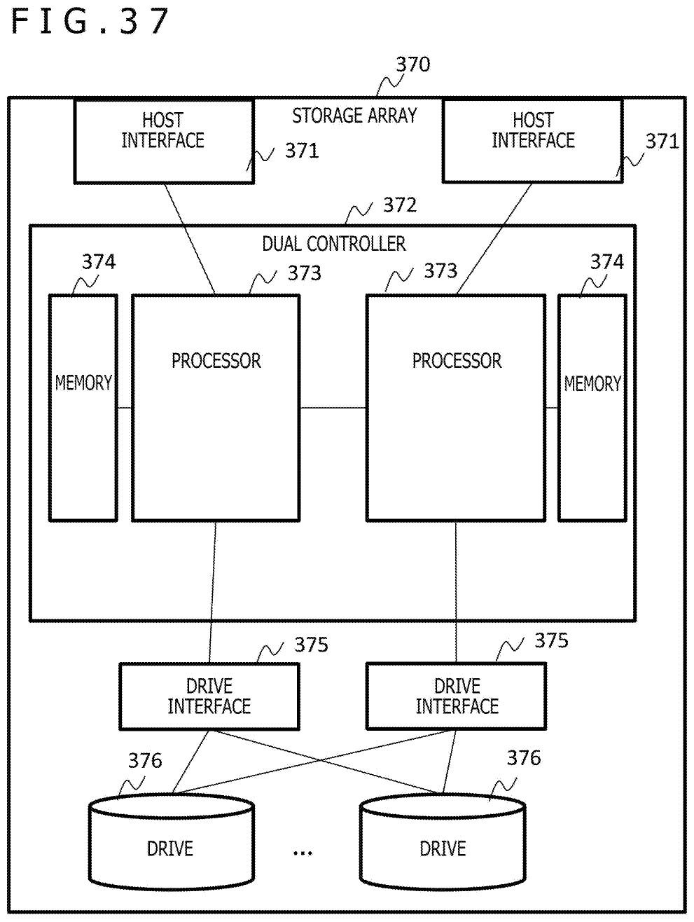

FIG. 37 is a block diagram depicting hardware configurations of the storage array. The storage array 370 has a host interface 371, a dual controller 372, two drive interfaces 375, and a plurality of drives 376. The dual controller 372 has two processors 373 and two memories 374.

The host interface 371 is a device that holds communication with a host computer via the communication network 900.

The processors 373 each execute a software program and execute desired processing as the storage array 370. The memories 374 each store the software program executed by each of the processors 373 and data used by each of the processors 373 in processing. The processor 373 and the memory 374 are duplexed.

The drive interfaces 375 are each an interface that relays the input/output processing performed by each of the processors 373 on each drive 376. The two drive interfaces 375 correspond to the two processors 373, respectively.

The drives 376 are each a storage device retaining the written data in a readable manner. A plurality of drives 376 are shared between the two processors 373.

As described so far, according to the present embodiment, the highly functional node is implemented in the storage array 370 that has a plurality of storage devices (drives 376), and the two processors 373 each having a physical interface (host interface 371) connected to a host and a physical interface (drive interface 375) connected to each storage device. In this way, implementing the highly functional node having the highly functional controller having relatively ample necessary amount of resources in the storage array having the plurality of storage devices and the two processors makes it possible to efficiently configure the storage system having the highly functional and redundant controllers.

### Sixth Embodiment

In the first embodiment, an example in which the front-end section transfers the I/O request to the front-end section in the storage node in which the controller in charge of the volume from or to which data is to be read or written is disposed in the case in which the controller in charge of the volume is not in the own node has been described. However, the embodiments are not limited to this example. In a sixth embodiment, an example of issuing an I/O request to the storage controller in the own node for input/output processing that satisfies a predetermined condition will be described.

For example, in the first embodiment, an example in which the front-end section transfers the request of Read I/O to the front-end section in the storage node in which the controller in charge of the volume from which data is to be read is disposed in the case in which the controller in charge of the volume is not in the own node in the data read processing has been described, as depicted in FIG. 12. However, the embodiments are not limited to this example.

In the sixth embodiment, as for the data read processing, a request of Read I/O is issued to the controller in the own node irrespectively of whether the controller in charge of the volume from which data is to be read is in the own node.

Furthermore, in the first embodiment, an example in which the front-end section transfers a request of Write I/O to the front-end section in the storage node in which the controller in charge of the volume to which data is to be written is disposed in the case in which the controller in charge of the volume is not in the own node in the data write processing has been described, as depicted in FIG. 13. However, the embodiments are not limited to this example.

For example, the configuration management section 325 can change a physical storage capacity allocated to a host as appropriate by thin provisioning, and control is exercised to change the capacity of the physical storage area allocated to the host as appropriate in a case in which the thin provisioning is made valid. In that case, an actually allocated physical storage area is relatively small, so that resources necessary for a case of executing functional processing is also relatively small. In the sixth embodiment, therefore, as for a request of the input/output processing on a volume to which a physical area is already allocated with respect to a host that exercises control to change the physical storage capacity to be allocated as appropriate, the front-end section issues an I/O request to the storage controller in the own node irrespectively of whether the storage controller in charge of the volume is in the own node or in the other node.

System configurations of the storage system according to the sixth embodiment are similar to those according to the first embodiment depicted in FIG. 1. In addition, hardware configurations of the storage node 300 according to the sixth embodiment are similar to those according to the first embodiment depicted in FIG. 2. Furthermore, software configurations of the resource saving node 320 and the highly functional node 330 according to the sixth embodiment are basically similar to those of the resource saving node 320 and the highly functional node 330 according to the first embodiment depicted in FIGS. 3 and 4. It is to be noted, however, that the sixth embodiment differs from the first embodiment in processing executed by the front-end sections 321 and 331.

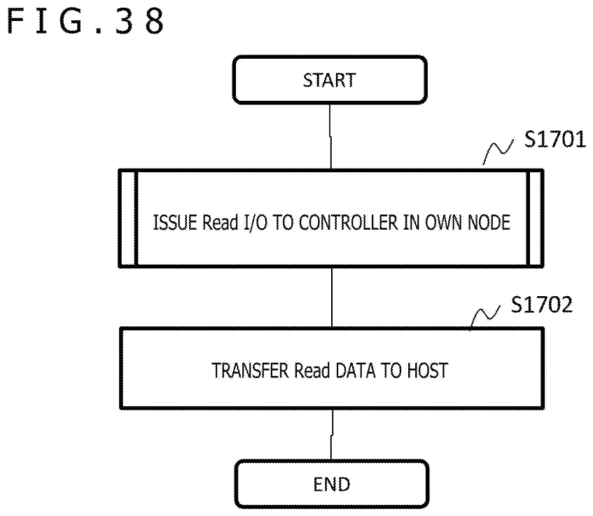

FIG. 38 is a flowchart illustrating data read processing executed by the front-end section according to the sixth embodiment. The present processing may be executed by the front-end section 321 in the resource saving node 320, and the same processing may be executed by the front-end section 331 in the highly functional node 330.

In the data read processing, the front-end section issues a request of Read I/O to the storage controller in the own node without condition (Step S1701). In addition, the front-end section transfers the read data to the host in response to a response from the storage controller (Step S1702).

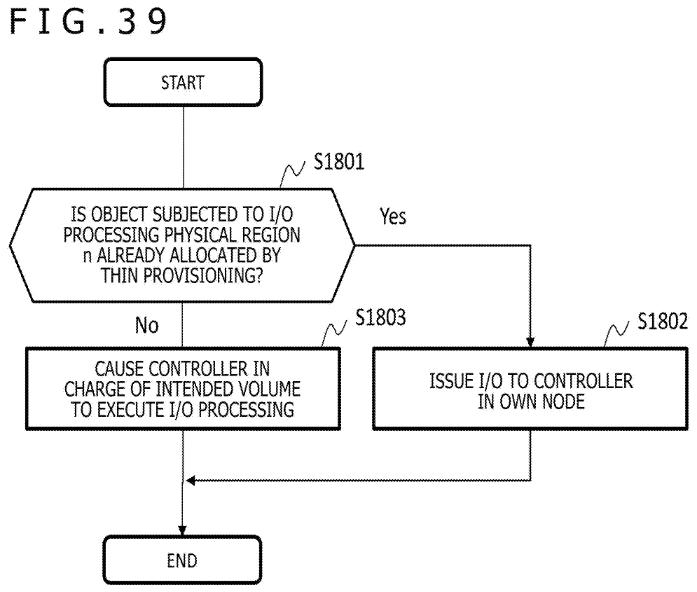

FIG. 39 is a flowchart illustrating input/output processing executed by the front-end section according to the sixth embodiment. The present processing is processing common to the front-end section 321 in the resource saving node 320 and the front-end section 331 in the highly functional node 330. Since the processing depicted in FIG. 38 is performed for the data read processing out of the input/output processing in the sixth embodiment, FIG. 39 is intended at the data write processing out of the input/output processing. It is to be noted, however, that only one of the processing of FIG. 38 and the processing of FIG. 39 can be applied. In a case of applying only the processing of FIG. 39, FIG. 39 is intended at both the data write processing and the data read processing.

With reference to FIG. 39, the front-end section determines whether an object subjected to the input/output processing requested from the host is a physical area already allocated by thin provisioning (Step S1801). In a case in which the object subjected to the input/output processing is an already allocated physical area, the front-end section issues an I/O request to the storage controller in the own node (Step S1802). On the other hand, in a case in which the object subjected to the input/output processing is not an already allocated physical area, the front-end section causes the storage controller in charge of the intended volume to execute the input/output processing (Step S1803). It is noted that cases include a case in which the storage controller in charge of the intended volume is in the own node and a case in which the storage controller in charge of the intended volume is in the other node, so that the front-end section performs processing in response to each case upon referring to the volume management table 363.

As described so far, according to the sixth embodiment, at least the front-end section 321 in the resource saving node 320 issues a read request to the first controller in the own node without transferring the read request to the front-end section 331 in the highly functional node 330. Since the data read processing is relatively small in necessary resources despite the function processing, causing the resource saving controller 322 in the resource saving node 320 to control the data read processing makes it possible to reduce inter-node communication while enabling efficient use of resources.

Furthermore, the configuration management section 325 can change the physical storage capacity allocated to the host as appropriate, and the front-end section 321 in the resource saving node 320 issues the request of the input/output processing on the volume to which the physical area is allocated with respect to the host that changes the allocated physical storage capacity as appropriate to the resource saving controller 322 in the own node without transferring the request to the front-end section 321 in the highly functional node 330. In the case in which control is exercised to change the capacity of the physical storage area allocated to the host as appropriate, necessary resources are relatively small even in the functional processing; thus, causing the first controller in the first storage node to control the function processing makes it possible to reduce inter-node communication while enabling the efficient use of resources.

While the embodiments of the present invention have been described above, the embodiments are given as an example for the description and not intended to limit the scope of the present invention only to the embodiments. A person skilled in the art can carry out the present invention in various other manners without departure from the scope of the present invention.

What is claimed is:

1. A storage system comprising:
a plurality of storage devices that store data; and
a plurality of controllers that process data input to and output from the storage devices,
at least one of the controllers enabling execution of function processing on the data input to and output from the storage devices,
the storage system further comprising:
a management section that changes the controllers that process the data on a basis of whether to execute the function processing on the data input to and output from the storage devices.

2. The storage system according to claim 1, wherein
the function processing includes any of snapshot, remote copying, deduplication, and compression.

3. The storage system according to claim 2, wherein
the management section sets, as a storage area, a first storage area to which the function processing is not applied and a second storage area to which the function processing is applied, and causes the different controllers to take charge of the first storage area and the second storage area, and
when a data input/output request is received, the data input/output request is transferred to the controller in charge of data associated with the data input/output request.

4. The storage system according to claim 2, wherein
a plurality of storage areas are provided, and whether to apply each of a plurality of series of the function processing is set in each of the plurality of storage areas, and
one storage area is selected in response to a type of the function processing requested to be executed.

5. The storage system according to claim 3, wherein
the management section causes the first controller to take charge of the first storage area, and causes the second controller higher in a processing performance than the first controller to take charge of the second storage area.

6. The storage system according to claim 3, wherein
the management section causes the first controller to take charge of the first storage area, and causes the second controller lighter in a load than the first controller to take charge of the second storage area.

7. The storage system according to claim 3,
the management section causing the first controller to take charge of the first storage area, and causing the second controller to take charge of the second storage area
the storage system further comprising:
a data protection section that makes redundant data associated with a data input request processed by the first or second controller, and that stores the redundant data in the plurality of storage devices.

8. The storage system according to claim 7, comprising:
a plurality of the first controllers; and
a plurality of the second controllers, wherein
the plurality of the first controllers form multiplexed redundant configurations, and
the plurality of the second controllers form multiplexed redundant configurations.

9. The storage system according to claim 7, comprising:
a plurality of nodes each having the first or second controller and the storage devices, wherein
the data protection section makes the data redundant using the storage devices in the plurality of nodes.

10. The storage system according to claim 9, wherein
the nodes each include a compute section that issues the data input/output request.

11. The storage system according to claim 7, comprising:
a plurality of nodes each having the first or second controller; and
the storage devices that can be used from the plurality of nodes.

12. A control method of controlling a storage system including a plurality of storage devices that store data and a plurality of controllers that process data input to and output from the storage devices, the control method, executed by a computer, comprising:
setting at least one of the controllers in such a manner that the at least one of the controllers is capable of executing function processing on the data input to and output from the storage devices; and
changing the controllers that process the data on a basis of whether to execute the function processing on the data input to and output from the storage devices.
